(19) United States
(12) Patent Application Publication
(10) Pub. No.: US 2026/0288762 A1
(43) Pub. Date: Sep. 24, 2026

(54) SYSTEM

(71) Applicant: SoftBank Group Corp., Tokyo (JP)

(72) Inventor: Yoshitaka SHIRAI, Tokyo (JP)

(73) Assignee: SoftBank Group Corp., Tokyo (JP)

(21) Appl. No.: 19/568,874

(22) Filed: Mar. 17, 2026

(30) Foreign Application Priority Data
Mar. 19, 2025 (JP) 2025-045268

(51) Int. Cl. G06F 16/28; G06F 16/242

(52) U.S. Cl. CPC G06F 16/285; G06F 16/242

(57) ABSTRACT

A system includes a processor that is configured to receive information from a user and analyze the information, acquire purchase history information and preference information of the user based on the analyzed information, and utilize a generative AI model by using a prompt for instructing the generative AI model to propose an optimal event measure based on the acquired information and a result of the analysis.

### CROSS-REFERENCE TO RELATED APPLICATION

This application is based on and claims priority under 35 USC 119 from Japanese Patent Application No. 2025-045268 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional event planning and promotion systems typically rely on static user segmentation, manually defined rules, or limited recommendation logic based solely on basic purchase history. Such approaches often fail to capture complex user intentions, fine-grained preferences, or changes in user context in real time. As a result, the proposed event measures may not align sufficiently with the individual user's actual needs or interests, which leads to low engagement rates and inefficient use of marketing resources.

Furthermore, known systems do not adequately utilize advanced generative AI models with tailored prompts to analyze user-provided information in combination with purchase history and preference information. In particular, conventional systems rarely take into account the user's emotional state when generating or adjusting event measures. Without recognition of the user's emotional state, the system may propose events at inappropriate timing, with unsuitable tone, or with benefits that do not resonate emotionally with the user, thereby reducing the effectiveness of promotional activities.

In addition, there is a lack of integrated mechanisms for delivering the optimized and emotionally adjusted event measures through smart devices that the user frequently operates. Existing solutions tend to treat analysis, event generation, emotional adjustment, and notification as separate processes, which limits real-time responsiveness and personalization.

Accordingly, there is a need for a system that can (i) receive and analyze user information, (ii) acquire purchase history and preference information based on such analysis, (iii) utilize a generative AI model via prompts to propose optimal event measures, (iv) further adjust the proposed event measures based on the user's emotional state, and (v) notify the user of the adjusted event measures through a smart device in an integrated and automated manner.

### SUMMARY

To solve the above-described problems, according to one aspect of the invention, there is provided a system comprising a processor, wherein the processor is configured to receive information from a user and analyze the information, acquire purchase history information and preference information of the user based on the analyzed information, and utilize a generative AI model by using a prompt for instructing the generative AI model to propose an optimal event measure based on the acquired information and a result of the analysis. By leveraging a generative AI model with a carefully designed prompt, the processor can generate highly tailored event measures that reflect complex relationships among the user's explicit input, historical purchase behavior, and preference patterns.

According to another aspect of the invention, the processor is further configured to analyze an emotional state of the user and adjust the proposed event measure based on a result of the analysis of the emotional state. In one implementation, the processor may infer the emotional state from the user's textual input, voice input, interaction patterns, or other biometric or behavioral signals. Based on such inference, the processor may modify, for example, the type of event, the timing of the proposal, the level of benefit, or the tone of the event description, so that the event measure is better aligned with the current emotional context of the user.

According to still another aspect of the invention, the processor is further configured to notify the user of the adjusted event measure through a smart device. The smart device may be, for example, a smartphone, a tablet, a smartwatch, or another network-connected terminal operated by the user. By delivering the adjusted event measure via the smart device, the system can provide real-time, context-aware notifications that are easily accessible to the user, thereby increasing the likelihood that the user will recognize, consider, and participate in the proposed event. Through the combination of the above features, the invention enables a highly personalized, emotionally aware, and device-integrated event proposal system that improves user engagement and the effectiveness of event measures.

The term “system” refers to a combination of hardware and software components, including at least one processor and associated memory, communication interfaces, and optionally one or more external devices, which cooperate to perform the functions described in the present specification and claims.

The term “processor” refers to any hardware device or combination of devices capable of executing instructions, such as a central processing unit (CPU), a graphics processing unit (GPU), a digital signal processor (DSP), a microcontroller, or a programmable logic device, and may include one processor or multiple processors operating in coordination.

The term “user” refers to a human individual who interacts, directly or indirectly, with the system by providing information, receiving event measures, and optionally participating in events proposed by the system.

The term “information from a user” refers to any data provided by the user or acquired from the user, including but not limited to text input, voice input, selection operations, behavioral logs, interaction histories, and any other explicit or implicit user-generated data.

The term “analyze” refers to processing data to extract features, patterns, meanings, or relationships, and may include operations such as parsing, classification, clustering, statistical analysis, inference, or transformation using rule-based logic, machine learning, or other algorithms.

The term “purchase history information” refers to data representing past purchase activities of the user, including, for example, product identifiers, product categories, purchase dates and times, prices, quantities, purchase channels, and associated transaction metadata.

The term “preference information” refers to data representing tendencies, likes, dislikes, or interests of the user, including, for example, favored product categories, favored brands, preferred price ranges, frequently selected attributes, and any inferred or explicitly provided preference indicators.

The term “generative AI model” refers to an artificial intelligence model capable of generating outputs such as text, structured data, or other content in response to input data and instructions, and may include, for example, large language models, generative neural networks, or other machine learning models configured for content generation.

The term “prompt” refers to data, including instructions, conditions, context information, and example inputs or outputs, provided to the generative AI model to guide or control the generation of outputs, including the generation of proposals for event measures.

The term “event measure” refers to a proposed event-related action or plan targeted to the user, including, for example, promotional campaigns, discount offers, product launch events, personalized recommendations, or invitations to participate in specific marketing or service activities.

The term “optimal event measure” refers to an event measure that is selected or generated as being suitable for the user according to one or more criteria, such as relevance to the user's purchase history information, preference information, and current context, and which is intended to maximize user engagement, satisfaction, or business effectiveness.

The term “emotional state of the user” refers to a condition or attitude of the user relating to emotions, such as happiness, sadness, interest, stress, excitement, or other affective states, which may be inferred from user input, behavior, or other signals.

The term “adjust the proposed event measure” refers to modifying, refining, or reselecting an event measure that has been initially proposed, based on additional information such as the user's emotional state, to change aspects such as content, timing, intensity of benefits, presentation style, or target products or services.

The term “smart device” refers to an electronic device capable of network communication and user interaction, including, for example, a smartphone, tablet, smartwatch, smart speaker, or other connected terminal operated by the user.

The term “notify the user” refers to providing information about an event measure to the user via a smart device, by means such as push notifications, messages, alerts, graphical displays, or audio output, such that the user can become aware of and optionally act upon the event measure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

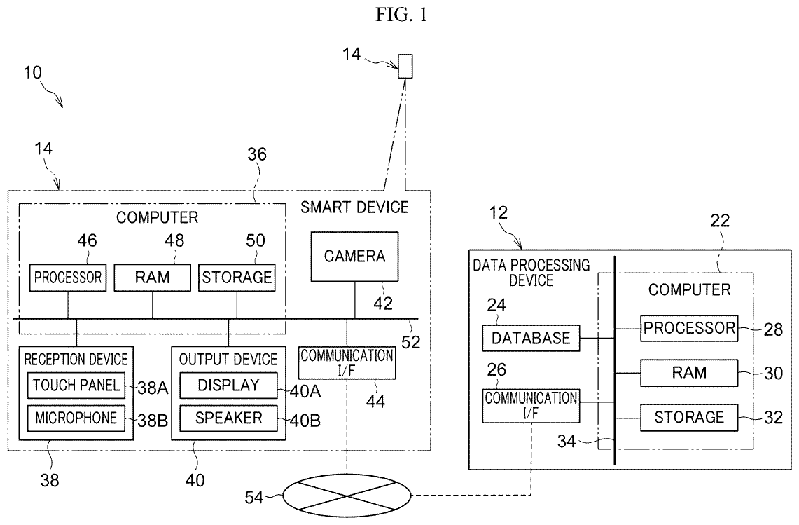

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

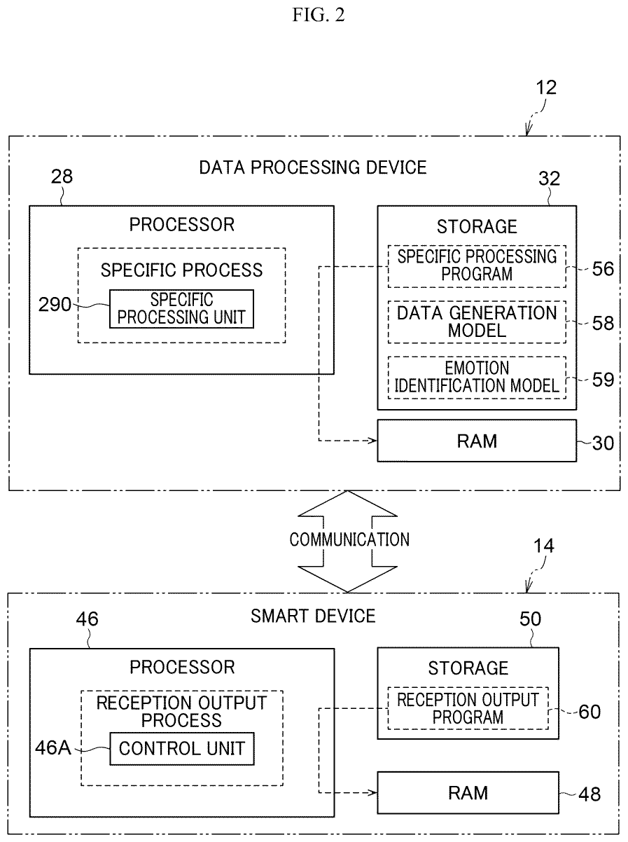

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented marketing support systems typically rely on static rule engines or simple statistical analysis to generate campaign proposals based on customer purchase history and preference information. In such systems, a processor generally applies pre-defined business rules to tabular customer data and outputs generic recommendations. As a result, the system is unable to adequately capture complex, evolving behavioral patterns of users, and cannot flexibly adapt proposal content to changes in customer segments or to the emotional state of the user operating the system. This often leads to suboptimal or irrelevant event measures, increased manual editing by operators, and inefficient use of computational resources.

Furthermore, in many existing architectures, data collection, feature extraction, and proposal generation are implemented as loosely coupled modules, without a closed feedback loop that utilizes the actual performance of executed measures. In such systems, the processor does not systematically re-input finalized measures and result information into the underlying models.

Accordingly, the system cannot improve its own generative behavior over time, and the computational models remain static or require offline retraining, which introduces latency and complexity. This lack of self-improving feedback degrades the technical performance of the computer system, for example by generating redundant proposals and causing unnecessary processing cycles.

Additionally, conventional use of generative models in marketing contexts frequently consists of ad hoc prompt engineering performed manually by a user. The processor may simply forward raw tabular data or a brief summary to a generative model, without programmatically constructing prompt sentences that encode machine-learned segments and behavioral features in a structured, machine-consumable manner. As a result, the generative model operates on incomplete or unstructured context, leading to unstable output quality, higher error rates, and a need for repeated invocations. This imposes a heavier computational burden on server resources, increases network traffic between system components, and reduces throughput.

Moreover, traditional systems do not integrate analysis of a user's emotional state into the computational pipeline for generating and adjusting proposals. In many cases, the processor does not analyze signals reflecting operator stress, satisfaction, or engagement, and therefore cannot adapt prompt content or proposal style to the operator's current condition. This omission can negatively affect interaction efficiency, because the system may present overly complex, lengthy, or inappropriate proposals at times when the user would benefit from simplified or more cautious suggestions. This mismatch contributes to increased interaction time, repetitive editing, and inefficient usage of display and input resources on the operation device.

Accordingly, there is a need for an improved computer-implemented system and server-side processing method that: (i) structurally acquires and preprocesses user-related data, (ii) automatically derives feature data and behavioral segments using machine learning algorithms, (iii) programmatically generates prompt sentences that instruct a generative model to produce tailored event measure candidates, (iv) incorporates emotional-state analysis to adjust prompt and output content, and (v) closes the loop by re-feeding finalized measures and associated result information into the computational models. Such a system should technically improve the way a computer manages data flows, allocates processing between analysis and generation, and iteratively refines model behavior, thereby enhancing the efficiency, stability, and quality of event measure generation compared to conventional approaches.

The specific processing by the specific processing unit 290 of the data processing device 12 in Example 1 is realized by the following means.

The present invention provides a server comprising a processor and a storage device, the processor being configured to execute instructions that cause the processor to receive target information from a user via an operation device and acquire the target information as structured data, to store the structured data in the storage device, to extract the structured data from the storage device and perform preprocessing on the structured data so as to generate feature data for each user based on purchase history information and preference information, to apply a machine learning algorithm to the feature data in order to extract behavioral characteristics and classify user groups according to the behavioral characteristics, to generate a prompt sentence including information on the user groups and the behavioral characteristics and instructing generation of optimal event measures, to execute a generative information processing model using the prompt sentence and the information on the user groups so as to generate event measure candidates described in natural language for each of the user groups, to convert the event measure candidates into structured data and transmit the structured data to the operation device so that a display device of the operation device displays the event measure candidates, to receive from the operation device modification content or confirmation instructions from the user with respect to the event measure candidates and store, in the storage device, the event measure candidates as finalized measures on the basis of the modification content or the confirmation instructions, and to re-input the finalized measures and result information related to the finalized measures into the machine learning algorithm and the generative information processing model so as to update subsequent generation processing of the event measure candidates, and the processor being further configured, in certain embodiments, to analyze information on an emotional state of the user acquired from the operation device and adjust content of the prompt sentence and the event measure candidates according to the emotional state. This enables a computer system to perform an integrated, feedback-driven pipeline in which structured user data is transformed into behavioral feature data, segments are automatically learned, prompt sentences are programmatically constructed for the generative model, proposals are iteratively refined based on user interaction and emotional context, and finalized outcomes are fed back into the models, thereby improving the technical efficiency, adaptability, and output quality of event measure generation compared to conventional systems.

The term “processor” refers to a hardware or virtual computation unit, such as a central processing unit or a processing core, that executes machine-readable instructions to perform arithmetic, logical, control, and input/output operations in the system.

The term “storage device” refers to a hardware or virtual memory component, such as a volatile memory or a non-volatile memory, that stores structured data, feature data, model parameters, prompt sentences, event measure candidates, finalized measures, and result information.

The term “operation device” refers to an information processing apparatus, such as a terminal or client device, including at least an input interface and a display device, which enables a user to transmit information to and receive information from the server.

The term “display device” refers to a visual output interface of the operation device, such as a screen or monitor, that presents event measure candidates and related information to the user.

The term “user” refers to a human operator who uses the operation device to input target information, review and edit event measure candidates, and confirm finalized measures.

The term “target information” refers to information related to one or more end customers or subjects to be analyzed, including at least purchase history information, preference information, and other attributes input by the user via the operation device.

The term “structured data” refers to data represented in a predefined format, such as a record, a table, or a data object, in which fields such as customer identifiers, product identifiers, timestamps, and categories are explicitly defined.

The term “purchase history information” refers to data indicating one or more past acquisition events of goods or services associated with a customer, including at least information on purchased items, dates or times of purchase, and categories or attributes of the items.

The term “preference information” refers to data indicating tendencies, interests, or likes and dislikes of a customer, including at least preferred categories, brands, price ranges, or usage patterns.

The term “preprocessing” refers to a series of computational operations applied to structured data before machine learning, including at least cleaning, normalization, aggregation, transformation, and feature extraction.

The term “feature data” refers to numerical or symbolic representations derived from structured data, where each feature dimension corresponds to a specific attribute or statistic of a user, such as purchase frequency, recency of purchase, or category distribution.

The term “machine learning algorithm” refers to a computational procedure that adjusts internal parameters or constructs models based on input data in order to detect patterns, make predictions, or classify data, including but not limited to clustering, classification, and regression methods.

The term “behavioral characteristics” refers to patterns or traits derived from feature data that describe how customers behave over time, including at least purchase tendencies, responsiveness to promotions, and category-specific interests.

The term “user groups” refers to sets of customers that are classified together based on similarity of behavioral characteristics, each set representing a segment used for generating targeted event measures.

The term “prompt sentence” refers to a textual instruction or query generated by the processor, which includes information on user groups and behavioral characteristics and serves as input to a generative information processing model to guide generation of event measure candidates.

The term “event measures” refers to planned actions or campaigns, such as promotions, events, recommendations, or communications, intended to influence customer behavior or engagement.

The term “event measure candidates” refers to proposed event measures generated in natural language by the generative information processing model, prior to confirmation or modification by the user.

The term “generative information processing model” refers to a computational model, such as a generative artificial intelligence model or language model, that receives a prompt sentence and related data and outputs new content, including natural-language descriptions of event measure candidates.

The term “natural language” refers to a human-readable language, such as English or another human language, that is understandable by the user without requiring specialized encoding or markup.

The term “finalized measures” refers to event measures that have been confirmed or modified by the user and stored by the processor as definitive plans for execution or evaluation.

The term “result information” refers to data indicating outcomes associated with finalized measures, including at least effectiveness indicators such as response rates, conversion metrics, or sales changes resulting from execution of the finalized measures.

The term “emotional state” refers to a condition or attitude of the user, such as stress level, satisfaction, or engagement, inferred from signals acquired via the operation device, including but not limited to interaction patterns, input behavior, or explicit feedback.

The term “portable information processing apparatus” refers to a mobile operation device, such as a handheld terminal or mobile computing device, that can be carried by a user and provides at least input and display functions for interaction with the server.

In one embodiment, a server cooperates with a terminal operated by a user to realize the claimed system. The server includes at least one processor, a main memory, a non-volatile storage device, and a communication interface connected via a communication network to the terminal. The terminal includes a processor, a memory, a display device, and an input interface such as a touchscreen or keyboard. The server executes dedicated server-side software including a data ingestion module, a feature extraction module, a machine learning module, a generative AI module, a feedback management module, and an interface module. The terminal executes client-side software, such as a web browser or a dedicated application, that provides an operation screen to the user.

The server uses a relational database management system, such as a SQL-based database engine, as the storage device for structured data. The server uses a programming runtime environment, such as a script execution environment, to execute data preprocessing code and machine learning algorithms. The server uses a machine learning library, such as an open-source statistical learning library, to implement clustering and classification algorithms. The server uses a neural-network-based language model, such as a transformer-type generative AI model, as the generative information processing model.

The server acquires target information from the user via the terminal. The user uses the terminal to access an operation screen implemented as a web-based dashboard using markup language and scripting language. The terminal displays input fields for customer identifiers, product identifiers, purchase dates, product categories, preference labels, and related attributes. The user enters purchase history information and preference information and instructs the terminal to submit the information. The terminal converts the input into structured data, for example, into a data object having key-value pairs for each field, and transmits this structured data to the server through an encrypted communication protocol.

The server receives the structured data and stores it as records in the storage device. The server defines table structures for customers, purchases, preferences, and campaign results.

For instance, the server uses a purchases table with columns for customer_id, product_category, product_id, purchase_timestamp, quantity, and price. The server stores preference information in a preferences table with columns for customer_id, preference_category, and preference_score. This explicit data schema enables the processor to perform efficient index-based retrieval and aggregation queries, thereby improving data access performance compared to unstructured storage.

The server performs preprocessing on the structured data to generate feature data. The server loads records from the database into an in-memory data structure such as a columnar data frame. The server converts textual timestamps to numerical representations such as Unix time or days since last purchase. The server aggregates purchases per customer and per category by computing, for example, total number of purchases in each category, total monetary amount per category, and recency measures such as minimum and maximum purchase timestamps. The server normalizes these aggregated values, for example by applying min-max scaling or z-score normalization, and stores the normalized feature vectors in an in-memory array, where each row corresponds to one customer and each column corresponds to one numerical feature.

The server applies a machine learning algorithm to the feature data to extract behavioral characteristics and classify user groups. In one embodiment, the server uses a clustering algorithm such as k-means clustering. The server initializes cluster centers, iteratively assigns each customer feature vector to the nearest center according to a distance metric such as Euclidean distance, and updates the cluster centers by computing the mean of feature vectors assigned to each cluster. The server repeats this process until a convergence criterion is met, for example when the change in cluster centers is below a specified threshold. The server thereby obtains a cluster index for each customer and computes cluster-level statistics such as average purchase frequency, dominant category, and average recency. In another embodiment, the server uses a neural-network-based autoencoder to compress feature data and then applies clustering in the latent space, thereby capturing non-linear behavioral patterns that are not apparent in the original feature space.

The server constructs user groups based on cluster assignments. The server defines each user group as a segment having a segment identifier, a list of member customers, and aggregated behavioral characteristics. For example, the server may define a “sports-focused” segment in which the average purchase frequency in a sports category exceeds a threshold and the recency of sports purchases is within a certain time window. The server stores information about each segment in the storage device, including the segment identifier, feature centroids, and statistics describing typical behavior. By structuring this segment information, the server enables subsequent prompt generation to include precise, machine-produced summaries of behavioral patterns, which improves the relevance and consistency of generated event measures.

The server generates a prompt sentence for the generative AI model. The server constructs the prompt sentence as a human-language text string that combines multiple elements: a description of each user group, numerical characteristics of each group, constraints on campaign type, and an explicit instruction to generate event measures. The server, for example, generates a prompt sentence such as:
“Based on the following customer segments and their behavioral characteristics, generate optimal marketing event measures. Segment A consists of customers with high purchase frequency in the ‘sports’ category, with an average of 5 purchases in the last 3 months and a last purchase within 10 days. Segment B consists of customers with high purchase frequency in the ‘fashion’ category, with an average of 4 purchases in the last 2 months and no sports category purchases in the last 12 months. For each segment, propose at least one natural-language event measure, such as a promotion event, discount campaign, or early-access offer. For example, for customers who frequently purchase sports goods, propose a promotion event for new sports shoes.”

The server, in another example, generates a prompt sentence including explicit constraints on tone and structure:
“Using the following segment descriptions, generate concise, actionable event measures. Use no more than three sentences per segment. For Segment S1 (sports enthusiasts: frequent purchases in sports categories, high recent activity), propose a new sports shoes trial event. For Segment S2 (price-sensitive general shoppers: low-frequency purchases but strong response to discounts), propose a time-limited discount campaign.”

The server provides these prompt sentences to the generative AI model as input. In one embodiment, the server executes a transformer-based neural network language model on the server hardware. The neural network includes an input embedding layer, multiple self-attention layers, feed-forward layers, layer normalization, and an output linear layer mapping to a vocabulary distribution. The server tokenizes the prompt sentence into tokens, converts tokens to embeddings, and propagates them through the transformer layers. The server uses a softmax function at the output layer to compute probability distributions over next tokens, and generates text autoregressively until a stopping condition such as an end-of-sequence token or maximum length is reached. During training or fine-tuning, the server uses a loss function such as cross-entropy between predicted tokens and reference tokens, and updates model weights using an optimization algorithm such as stochastic gradient descent with momentum or an adaptive method. The server may perform additional fine-tuning on domain-specific corpora containing historical event measures and campaign descriptions, thereby adapting the generative model to the specific technical domain of marketing event generation.

The server can alternatively access an external generative AI service via an application programming interface. In this case, the server formats the prompt sentence as a text payload, transmits it to the external model, and receives generated text from the external model. The server still performs pre- and post-processing locally, such as segment summarization, prompt construction, and structuring of generated outputs.

The server generates event measure candidates described in natural language. The generative AI model produces text that describes specific event measures for each segment. The server parses the generated text and associates each portion of the text with the corresponding user group. The server may impose structural constraints on the generation by providing examples within the prompt, such as:
“For example: For Segment A (sports enthusiasts), propose: ‘Organize a weekend running shoes trial event and send invitations to customers who have purchased sports shoes at least three times in the last six months.’”

By incorporating such examples, the server encourages the generative AI model to output structured, concise, and segment-specific proposals. The server converts the generated text into structured data by assigning identifiers, segment references, and text fields. The server stores these event measure candidates in the storage device and returns them to the terminal. The terminal receives the event measure candidates from the server. The terminal parses the structured data and presents the event measure candidates on the display device. The terminal displays each candidate with associated segment information, such as segment name, size, and key behavioral characteristics. The user views the proposals and may modify text fields, adjust discount percentages, change event dates, or add constraints using the input interface. The terminal transmits modification content and confirmation instructions to the server when the user approves or confirms the event measures.

The server receives the modification content and stores the finalized measures. The server marks each event measure candidate as finalized upon receiving a confirmation instruction, while preserving a link to the original AI-generated text. The server stores the finalized measures in the storage device, along with associated parameters such as execution period, communication channels, and target segments. The server later receives or imports result information, such as response rates, conversion metrics, or revenue impacts, into the storage device. The server links this result information to the corresponding finalized measures by unique identifiers.

The server re-inputs the finalized measures and result information into the machine learning algorithm and the generative AI model. The server updates feature data to include additional dimensions representing sensitivity to certain types of measures, such as responsiveness to discount campaigns versus event invitations. The server re-trains or incrementally updates clustering models or classification models using the extended feature data, thereby altering the segmentation structure based on observed effectiveness. The server also uses finalized measures and their outcomes as training data for fine-tuning the generative AI model, for example by optimizing the model to produce proposals that historically correlate with higher performance. This feedback loop reduces the need for manual tuning and allows the server to refine computational models based on machine-observed effects rather than manual rules. The server, in one embodiment, analyzes information about the emotional state of the user.

The terminal measures interaction patterns, such as editing frequency, time spent per proposal, or explicit feedback ratings, and sends indicators to the server. The server uses a lightweight classifier, for example a logistic regression or a shallow neural network, to infer a coarse emotional state such as “overloaded,” “neutral,” or “satisfied.” The server adjusts the prompt sentence and event measure candidates according to this emotional state. For instance, when the user appears overloaded, the server modifies the prompt sentence to instruct the generative AI model to produce fewer, more concise proposals, thereby reducing cognitive load and improving interaction efficiency. This dynamic adjustment represents a non-conventional use of emotional signals to control the behavior of the generative model and the volume of generated data, which leads to reduced processing time, lower network traffic, and more efficient use of the display device.

The server improves computer technology in several aspects. First, the server reduces computational redundancy by structuring data flows and enforcing a strict sequence of preprocessing, feature extraction, segmentation, prompt construction, and generation. Because the server generates prompt sentences that encode machine-learned behavioral segments and numerical features, the generative AI model receives well-structured context and can produce higher-quality proposals with fewer model invocations. This reduces overall processor time and energy consumption compared to naive approaches that repeatedly query a generative model with unstructured or raw data. Second, the server uses clustering and feature extraction to compress high-dimensional purchase histories into compact feature vectors, which are more efficient to store and transmit than raw transactional logs. This compression reduces database size, improves query speed, and decreases communication load between the database and the machine learning module.

Third, the server implements a feedback-driven optimization loop in which finalized measures and result information are re-introduced into machine learning and generative models. This loop allows the models to improve automatically over time based on real performance data, rather than requiring manual rule updates or offline retraining. As a result, the server increases the precision of segmentation and the relevance of generated proposals, thereby reducing the rate of proposals that need extensive manual editing. This directly improves computational efficiency because fewer generation cycles and fewer user interactions are required to reach acceptable proposals.

Fourth, the server employs explicit algorithms and data structures for emotional-state-driven adaptation of prompts and outputs. Unlike conventional systems that ignore operator conditions, the server uses internal classifiers and rules to change the length, complexity, and number of generated outputs. This reduces unnecessary rendering and network transmissions when the user is in a state where only high-priority proposals are beneficial. The server thus uses emotional signals to control resource usage in a non-traditional manner, improving system responsiveness and throughput.

In another embodiment, the server uses alternative machine learning algorithms. The server may apply hierarchical clustering to capture multi-level segment hierarchies, or graph-based clustering when relationships between customers or products form a network. The server may use gradient-boosted decision trees or deep neural networks to predict effectiveness scores for candidate measures, and then condition prompt sentences on high-score combinations. The server may also use different neural network architectures for the generative AI model, such as encoder-decoder architectures with attention, or recurrent networks with gating mechanisms, depending on computational constraints and desired output style.

In yet another embodiment, the terminal is implemented as a portable information processing apparatus such as a smartphone or tablet. The terminal caches segment summaries and event measure candidates locally to reduce repeated requests to the server. The server adapts payload sizes and update intervals based on network conditions, thereby reducing bandwidth usage. For example, when network latency is high, the server aggregates segment updates into batch transmissions, and the terminal reuses locally stored linguistic templates for minor adjustments, thereby further reducing communication overhead.

The server, the terminal, and the described software modules thus collectively implement a concrete technical architecture, specific data structures, and non-conventional processing flows that improve the way a computer system processes, stores, and generates event measures. The server does not merely automate human decision-making; instead, the server restructures data, applies machine-learned segmentation, constructs algorithmically derived prompt sentences, and drives a generative AI model under technical constraints to achieve improvements in processing speed, memory usage, network efficiency, and accuracy of generated outputs.

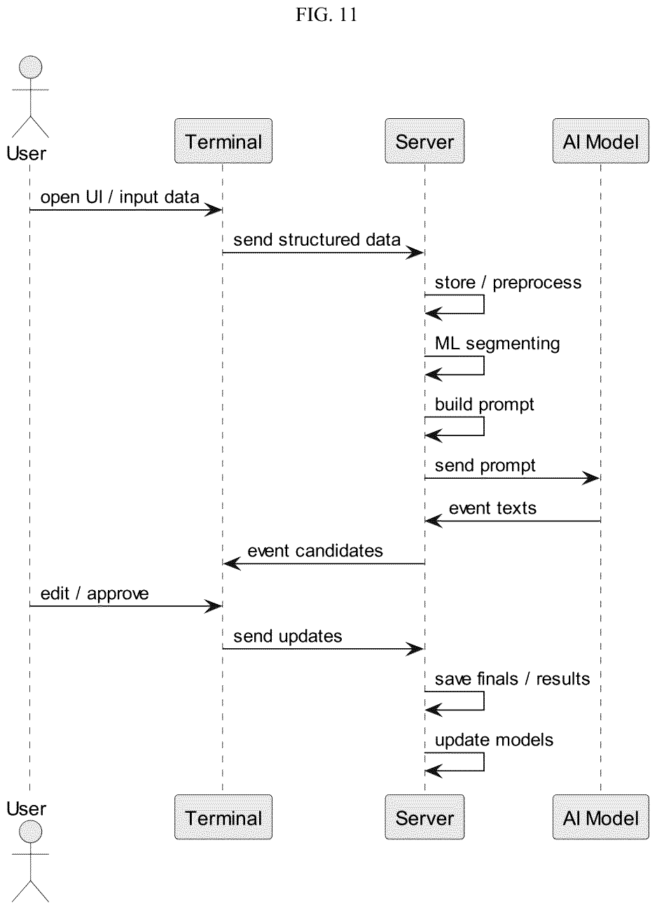

The following describes the processing flow using FIG. 11.

### Step 1:

The user operates the terminal to open an application or web browser and access an operation screen provided by the server. The terminal sends a request for the operation screen to the server as input, and the server returns markup data and script data as output.

### Step 2:

The terminal renders the received markup data on the display device and executes the script data to construct input forms for customer identifiers, product identifiers, purchase dates, product categories, and preference labels. The user views the display and uses the input interface to enter purchase history information and preference information. The input in this step is raw keystroke and touch data, and the output is a set of field values stored in the terminal's memory.

### Step 3:

The terminal converts the field values into structured data by creating a data object that contains key-value pairs such as “customer_id,” “product_category,” “purchase_timestamp,” and “preference_label.” The terminal applies simple validation, such as checking date formats and mandatory fields, based on the input values. The input in this step is the field values, and the output is a validated structured data object.

### Step 4:

The terminal transmits the structured data object to the server via a communication network using a request message. The input in this step is the structured data object held in the terminal's memory, and the output is a network packet containing the structured data, which reaches the server.

### Step 5:

The server receives the network packet and extracts the structured data object from the request message. The server parses the structured data, checks field types, and converts data formats as needed, for example converting timestamp strings to an internal time representation. The input in this step is the received structured data object, and the output is a normalized record ready for storage.

### Step 6:

The server stores the normalized record in a storage device by inserting it into relational tables for customers, purchases, and preferences. The server may generate indexes on keys such as customer identifiers and timestamps to accelerate later queries. The input in this step is the normalized record, and the output is a persistent database entry along with updated index structures.

### Step 7:

The server receives a request from the terminal or from an internal scheduler to perform analysis and generate event measure candidates for one or more customers or segments. The input in this step is a request specifying a target set of customers or a time window, and the output is a query plan for retrieving relevant records from the storage device.

### Step 8:

The server executes database queries to retrieve purchase history information and preference information for the specified target. The server reads records from the purchases table and preferences table, and loads them into an in-memory data structure such as a table-like array. The input in this step is the query plan and the stored database contents, and the output is a collection of raw records grouped by customer.

### Step 9:

The server performs preprocessing on the collection of raw records. The server filters out records with missing essential fields, converts categorical values into internal codes, and transforms textual timestamps into numerical values. The server then aggregates records per customer and per category by computing statistics such as purchase counts, total amounts, and recency metrics. The input in this step is the collection of raw records, and the output is an aggregated dataset in which each row corresponds to a customer and each column corresponds to a numerical or categorical feature.

### Step 10:

The server normalizes and encodes the aggregated dataset to generate feature vectors. The server applies normalization methods such as min-max scaling or z-score normalization to numerical columns and applies one-hot encoding or embedding indices to categorical columns. The server assembles the processed columns into a matrix of feature vectors. The input in this step is the aggregated dataset, and the output is a feature matrix suitable for machine learning processing.

### Step 11:

The server applies a machine learning algorithm to the feature matrix to extract behavioral characteristics and classify user groups. The server may use a clustering algorithm such as k-means, initializing cluster centers, computing distances between each feature vector and each center, assigning each vector to the closest center, and updating centers based on assigned vectors. The input in this step is the feature matrix and algorithm parameters such as cluster count and convergence threshold, and the output is a set of cluster assignments and cluster statistics for each user.

### Step 12:

The server constructs user groups based on cluster assignments. The server creates segment records that include a segment identifier, a list of member customers, average feature values, and dominant categories. The server may store these segments in a dedicated segment table in the storage device. The input in this step is the cluster assignments and cluster statistics, and the output is a structured representation of user groups with associated behavioral characteristics.

### Step 13:

The server generates a prompt sentence for a generative AI model. The server converts the segment information and behavioral characteristics into natural-language descriptions and combines them with explicit instructions for generating event measures. The server concatenates these descriptions into a text string such as: “Based on the following customer segments and their behavioral characteristics, generate optimal marketing event measures. Segment A consists of customers with high purchase frequency in the ‘sports’ category, with an average of 5 purchases in the last 3 months and a last purchase within 10 days. For each segment, propose at least one natural-language event measure, such as a promotion event, discount campaign, or early-access offer.” The input in this step is the structured segment information, and the output is the prompt sentence as a natural-language text string.

### Step 14:

The server tokenizes the prompt sentence using a tokenizer compatible with the generative AI model. The server maps each token to an integer identifier and then to an embedding vector. The input in this step is the prompt sentence text, and the output is a sequence of embedding vectors that represents the prompt in a numerical form.

### Step 15:

The server executes the generative AI model on the sequence of embedding vectors. The server passes the embeddings through multiple layers of a neural-network architecture, such as a transformer with self-attention, feed-forward layers, and normalization layers. The server computes, at each position, a probability distribution over possible next tokens using a softmax function. The server selects tokens according to the probability distribution, for example via greedy decoding or sampling with a temperature parameter, and iteratively generates output tokens until a termination condition is met. The input in this step is the sequence of embedding vectors and model parameters, and the output is a sequence of generated tokens representing proposed event measures.

### Step 16:

The server converts the sequence of generated tokens into a natural-language text string that constitutes event measure candidates. The server may insert segment identifiers and delimiters to separate proposals for different user groups. The input in this step is the sequence of generated tokens, and the output is a set of natural-language event measure descriptions.

### Step 17:

The server parses the generated natural-language text and structures it into data objects that associate each event measure description with a corresponding segment identifier or customer identifier. The server assigns internal identifiers to each proposal and optionally adds metadata such as a generation timestamp and model version. The input in this step is the continuous text of generated proposals, and the output is a collection of structured event measure candidate records.

### Step 18:

The server stores the structured event measure candidate records in the storage device and transmits them to the terminal. The server converts the records into a response format and sends them via the communication interface. The input in this step is the structured candidate records, and the output is a response message containing the event measure candidates for display on the terminal.

### Step 19:

The terminal receives the response message and parses the contained event measure candidate records. The terminal extracts text descriptions, segment identifiers, and metadata, and constructs user interface elements such as lists, cards, or tables. The input in this step is the response message from the server, and the output is an internal representation of the event measure candidates ready for rendering.

### Step 20:

The terminal displays the event measure candidates on the display device. The terminal renders each proposal along with associated segment information and provides interaction controls such as edit buttons, approval buttons, and rejection buttons. The input in this step is the internal representation of event measure candidates, and the output is a visual presentation that the user can read and manipulate.

### Step 21:

The user reviews the displayed event measure candidates and determines whether modifications are necessary. The user may select a proposal, open an editing interface, and change text content, parameters such as discount rates, or scheduling information. The input in this step is the visual presentation of proposals, and the output is a set of user edits and approval decisions expressed as interaction events.

### Step 22:

The terminal collects the user's edits and approval decisions and converts them into structured modification content and confirmation instructions. The terminal bundles this information into a request message addressed to the server. The input in this step is the user's interaction events, and the output is a structured message containing modified event measure data and status flags such as “approved” or “rejected.”

### Step 23:

The terminal transmits the structured modification content and confirmation instructions to the server over the communication network. The input in this step is the structured message held by the terminal, and the output is a network packet carrying the finalized or modified event measure data to the server.

### Step 24:

The server receives the network packet and extracts the modification content and confirmation instructions. The server identifies the corresponding event measure candidates in the storage device using identifiers and updates their status to “finalized,” “modified,” or “rejected” as indicated. The input in this step is the received modification content and confirmation instructions, and the output is an updated set of records in the storage device representing finalized measures and their relationship to original candidates.

### Step 25:

The server stores, as finalized measures, the event measure candidates that are confirmed or modified by the user. The server records finalized text, associated segments, execution parameters, and versioning information. The server links each finalized measure to a reference of the generative AI model output that produced the original candidate. The input in this step is the updated event measure candidate records, and the output is a finalized measure table or dataset in the storage device.

### Step 26:

The server later receives or retrieves result information associated with the execution of finalized measures, such as response rates or conversion metrics. The server matches the result information with the corresponding finalized measures by common identifiers and stores the matched pairs in the storage device. The input in this step is external or internal performance data, and the output is a dataset of measure-result pairs.

### Step 27:

The server uses the measure-result pairs as additional input to the machine learning module. The server augments the feature data for customers and segments with new attributes representing historical effectiveness of event types, response sensitivity, and channel preference. The input in this step is the measure-result dataset and existing feature data, and the output is an extended feature matrix incorporating effectiveness-related dimensions.

### Step 28:

The server retrains or updates the machine learning models and, optionally, the generative AI model using the extended feature matrix and measure-result pairs. The server computes model gradients based on a loss function that may combine clustering quality with prediction error for effectiveness scores, and updates model parameters using an optimization algorithm. The input in this step is the extended feature matrix, the measure-result data, and current model parameters, and the output is updated models that reflect learned relationships between event designs and real-world outcomes.

### Step 29:

The server generates updated segment definitions and new prompt sentences based on the retrained models. The server repeats feature extraction, segmentation, prompt construction, and generative processing using updated parameters, which produce more accurate and efficient event measure candidates in subsequent cycles. The input in this step is the updated models and newly collected customer data, and the output is refined segments and optimized prompt sentences for future interactions with the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented promotion systems typically retrieve customer purchase history and preference information from a data store and apply simple rule-based logic or static templates to determine promotion content. In such systems, event recommendations are often generated by predefined mappings between product categories and generic campaign texts, without deep analysis of behavioral data. As a result, the system frequently produces promotions that are only loosely related to actual user interests, and that fail to adapt over time to changes in user behavior. This leads to low response rates and inefficient use of computational and communication resources, since many notifications are transmitted but ignored by users.

Moreover, in many existing architectures, the generation of promotion content and the decision to notify a user are implemented as separate, weakly coupled components. A content generation component may operate without feedback from user responses, and a notification component may merely broadcast promotions when a user is detected near a store location, without considering individual participation tendencies. This separation prevents the system from learning which types of events are effective for which users, and leads to redundant processing, such as repeatedly generating similar promotions that a user has consistently declined.

From a computer technology standpoint, known systems do not exploit modern machine learning models in a unified pipeline that: (i) converts heterogeneous behavioral data into machine-processable feature data, (ii) uses a trained model to derive latent user interest signals, (iii) automatically constructs semantically rich prompt sentences, and (iv) invokes a generative model to produce structured, machine-usable event information, all within a closed feedback loop that incorporates user responses as training data. In typical implementations, generative models, if used at all, are manually prompted by human operators, and the generated free-form text is not systematically converted back into structured records suitable for automated notification control and model retraining.

Furthermore, conventional location-based promotion systems usually treat user location as a simple trigger for sending precomputed offers, without tightly integrating spatial context with dynamically generated, personalized event content. They often lack a mechanism whereby server-side components compute distances using stored facility coordinates, evaluate validity periods of events, and decide, at the time of notification, whether a particular event record is actually appropriate to send to a particular user at a particular place and time.

Accordingly, there is a need for an improved computer-implemented system that can, in an integrated manner, (1) acquire and preprocess user transaction history and preference data into feature data, (2) apply a trained model to obtain interest analysis results, (3) automatically generate prompt sentences for a generative model, (4) obtain natural language descriptions of personalized event measures from the generative model and convert them into structured event records, (5) use server-side computation of user location and event validity to control notification delivery, and (6) accumulate user response information as learning data to iteratively refine both the analysis model and the generative model. Such a system would improve the technical functioning of the server by reducing unnecessary notifications, improving the relevance of generated event content, and enabling more efficient utilization of storage, processing, and communication resources through a closed-loop, data-driven architecture.

The specific processing by the specific processing unit 290 of the data processing device 12 in Application Example 1 is realized by the following means.

The present invention provides a server comprising a processor and a storage device, the processor being configured to execute instructions to receive information including user identification information from a user terminal; acquire, based on the identification information, transaction history information and preference information associated with the user from the storage device; preprocess the acquired transaction history information and preference information by using an information processing program to generate feature data including numerical feature values; input the feature data into a trained information processing model to obtain an analysis result indicating a degree of interest of the user with respect to one or more event types; generate, based on the analysis result and the transaction history information and the preference information, a prompt sentence for input to a generative information processing model; input the prompt sentence into the generative information processing model to obtain natural language text indicating content of a personalized sales promotion event measure for the user; extract, from the natural language text, structured event information including at least an event name, an implementation place, an implementation period, and a target product group; register the structured event information in association with the identification information in the storage device; acquire position information from a portable terminal associated with the user; compare the position information with facility position information stored in the storage device to calculate a distance between a current position of the user and a facility; determine, based on the distance and the implementation period, whether the structured event information is a notification target; generate, according to a result of the determination, a notification message based on the structured event information; transmit the notification message to the portable terminal via a communication network; receive, from the portable terminal, response information including participation information with respect to the notification message; record the response information in association with the identification information in the storage device; and accumulate the response information as learning data for use as input data for the trained information processing model and for generating subsequent prompt sentences for the generative information processing model. This enables the server to implement an integrated, closed-loop promotion control pipeline in which user behavioral data is transformed into feature data, analyzed to derive interest signals, converted via automatically generated prompt sentences into personalized event descriptions by a generative model, and then fed back with user response information to continuously refine model behavior, thereby improving the technical performance of event generation, selection, and notification processes in a computer system.

The term “processor” refers to one or more hardware computation units configured to execute instructions, including but not limited to a central processing unit, a graphics processing unit, or another programmable logic device, that performs operations for implementing functions of the system.

The term “storage device” refers to one or more hardware data storage units, including but not limited to a magnetic storage device, an optical storage device, a semiconductor memory, or a combination thereof, configured to store programs, models, event information, and user-related information.

The term “user” refers to a person or entity that is associated with transaction history information, preference information, and identification information processed by the system.

The term “user terminal” refers to an information processing apparatus operated by the user, including but not limited to a portable terminal, a stationary terminal, or another communication-capable device, that can transmit information to and receive information from the server.

The term “portable terminal” refers to a mobile information processing apparatus, including but not limited to a smartphone, a tablet computer, or a handheld communication device, capable of wireless communication and acquisition of position information.

The term “identification information” refers to data that uniquely or quasi-uniquely identifies a user or a user terminal within the system, including but not limited to a user ID, an account ID, a device ID, or a combination thereof.

The term “transaction history information” refers to data indicating past interactions between the user and a transaction environment, including but not limited to records of purchased items, transaction dates and times, transaction amounts, and associated product categories.

The term “preference information” refers to data indicating tendencies or likes of the user with respect to goods, services, or event types, including but not limited to explicit preference settings, inferred interest categories, and tags derived from past behavior.

The term “information processing program” refers to a set of instructions executable by the processor to perform operations on data, including but not limited to preprocessing, feature extraction, normalization, aggregation, and transformation of user-related information.

The term “feature data” refers to data in which characteristics of the transaction history information and the preference information are represented in a machine-processable form, including but not limited to vectors, matrices, or tensors composed of numerical feature values.

The term “numerical feature values” refers to numerical representations of properties derived from raw user-related data, including but not limited to counts, frequencies, recency scores, category encodings, and embedding values generated for use by a model.

The term “trained information processing model” refers to a computational model that has been trained using training data to perform analysis of feature data, including but not limited to a machine learning model or a statistical model, that outputs an analysis result such as an interest score.

The term “analysis result” refers to output data obtained from the trained information processing model when feature data is input, the output data indicating at least a degree of interest of the user in one or more categories, items, or event types.

The term “generative information processing model” refers to a computational model configured to generate data, including but not limited to a generative artificial intelligence model or a language model, that produces natural language text in response to an input prompt.

The term “prompt sentence” refers to a text string constructed by the processor and input into the generative information processing model, the text string including information such as transaction history information, preference information, and the analysis result, and serving as a condition for generation of natural language text.

The term “natural language text” refers to character data expressed in a human language, generated by the generative information processing model, and indicating content of a personalized sales promotion event measure for the user.

The term “personalized sales promotion event measure” refers to a sales promotion plan or activity whose content is adapted to the user based on the user's transaction history information, preference information, and analysis result, and which is expressed at least in part in natural language text.

The term “structured event information” refers to data obtained by extracting, from the natural language text, specific elements of an event in a structured format, including but not limited to an event name, an implementation place, an implementation period, and a target product group.

The term “event name” refers to textual information that designates or titles a specific sales promotion event.

The term “implementation place” refers to information indicating a location at which a sales promotion event is carried out, including but not limited to a physical store, a facility, or a defined area.

The term “implementation period” refers to information indicating a time interval during which a sales promotion event is valid or conducted, including but not limited to a start time and an end time.

The term “target product group” refers to one or more categories or sets of goods or services that are the subject of a sales promotion event.

The term “facility position information” refers to data representing geographic positions of one or more facilities, including but not limited to coordinates, addresses, or location identifiers associated with stores or venues.

The term “position information” refers to data indicating a geographic location of the portable terminal, including but not limited to coordinate information acquired via a positioning system or network-based location service.

The term “distance” refers to a value calculated based on the position information and the facility position information, representing a spatial separation between the current position of the user and a facility.

The term “notification target” refers to structured event information that has been determined by the processor, based on at least the distance and the implementation period, to satisfy conditions for notification to the user.

The term “notification message” refers to data generated by the processor based on the structured event information and transmitted to the portable terminal, the data including information that enables the portable terminal to present the event to the user.

The term “response information” refers to data transmitted from the portable terminal to the server in response to the notification message, including but not limited to participation information, non-participation information, or other user reaction information.

The term “participation information” refers to data indicating an intention or decision of the user to participate in or to accept a sales promotion event.

The term “learning data” refers to data accumulated for use in training, retraining, or fine-tuning the trained information processing model and in generating subsequent prompt sentences for the generative information processing model, including at least the response information and associated user-related information.

The server implements one or more embodiments of the present invention by executing a program stored in a storage device. The server uses commercially available hardware, such as a multi-core central processing unit and, in some embodiments, a graphics processing unit for accelerating numerical computation. The server runs an operating system such as a general-purpose server operating system and executes an application stack that may include, for example, a scripting language runtime such as Python, a numerical computation library such as a tensor computation framework, and data processing libraries such as a tabular data processing library and a vectorized numerical library. The server communicates with a database management system, such as a relational database, and with a generative AI model that may be deployed on the same hardware or accessed over a network.

The server stores, in the storage device, transaction history information, preference information, facility position information, trained model parameters, generative AI model access information, and structured event information. The server stores transaction history information in relational tables, for example in a table having fields for user identification, item identification, purchase timestamp, quantity, price, and product category. The server stores preference information in another table including user identification and preference category scores. The server stores facility position information in a table including facility identifiers and geographic coordinates.

The server generates a program that defines modules for data acquisition, feature extraction, model inference, prompt sentence generation, generative model interaction, event structuring, location-based decision making, notification control, and response logging. The server implements the data acquisition module as a software component that issues queries to the relational database using a database driver. The server executes selection queries to retrieve transaction history rows and preference rows corresponding to a user identification. The server represents the retrieved records as in-memory data structures, such as arrays or tables, suitable for further processing.

The server implements the feature extraction module by using a tabular data processing library and a vectorized numerical library. The server converts categorical values such as product categories into numerical representations by assigning category indices or performing one-hot encoding. The server computes aggregated features per user, including purchase frequency for each category, average inter-purchase interval, recency scores such as an exponentially decayed value based on the time elapsed since the last purchase, and monetary features such as total spending. The server concatenates these features into fixed-length feature vectors. The server also optionally generates embedding vectors for categories by using a previously trained embedding layer stored in the storage device. The server thereby represents heterogeneous historical data in a machine-processable format that improves cache locality and numerical stability, which contributes to faster and more accurate model inference compared to manual, rule-based lookups.

The server implements the trained information processing model as a neural network model instantiated in a tensor computation framework. In one embodiment, the server uses a feed-forward neural network comprising an input layer that accepts the feature vectors, one or more hidden layers, and an output layer that produces interest scores. The server configures each hidden layer as a fully connected layer with a rectified linear unit activation function, and configures the output layer with a sigmoid or softmax activation function depending on whether the model outputs independent interest probabilities or normalized category probabilities. The server stores the layer weights and biases as numerical tensors in the storage device. The server loads these tensors into main memory during initialization and uses them for inference.

The server trains the neural network model offline by using historical feature data and labeled interest outcomes derived from past user behavior, such as whether users accepted or declined certain events. The server defines a loss function, such as a cross-entropy loss for classification of event type interest or a mean squared error for regression of interest scores.

The server performs gradient-based optimization, such as stochastic gradient descent or an adaptive optimization algorithm, to update the weights. The server computes gradients by backpropagation through the network, and updates the weights according to the learning rate and optimization rule. The server may apply regularization methods such as dropout, L2 weight decay, or batch normalization to improve generalization and convergence. The server then stores the resulting trained weights in the storage device for subsequent online inference. The server uses the trained information processing model during operation by passing feature vectors as input and computing layer-wise activations. The server applies matrix multiplications and non-linear activation functions in a sequence corresponding to the neural network architecture. The server obtains, at the output layer, an analysis result consisting of one or more interest scores that indicate the degree of interest of the user in various event categories, such as “wine tasting event”, “sports clinic event”, or “cosmetics demonstration event”. The server interprets these scores according to predetermined thresholds and ranking logic and selects one or more candidate event categories for use in subsequent generative processing.

The server generates a prompt sentence for the generative AI model by assembling text fragments according to templates stored in the storage device. The server selects key items from the transaction history, such as frequently purchased items or recently purchased items, and combines this information with the interest scores. The server uses string concatenation operations to embed variable parts, including item names, category labels, and numeric interest values, into a natural language template. For example, the server generates a prompt sentence such as:
“Customer purchase history: wine, cheese, premium snacks. Model-estimated interests: strong interest in new wine tasting events and cheese pairing sessions. Please generate a personalized in-store promotion event that will attract this customer.”

The server may generate other prompt sentences, such as:
“Customer purchase history: wine, cheese. Model inference: the customer enjoys tasting new wines paired with cheese. Please generate a detailed in-store promotion event, including title, short description, and key benefits for the customer.” The server uses these prompt sentences as inputs to a generative AI model.

The server interacts with the generative AI model by transmitting the prompt sentence through an application programming interface. The generative AI model is implemented as a language model, which in one embodiment is a transformer-based neural network with multiple self-attention layers, feed-forward layers, and layer normalization. The server encodes the prompt sentence into token sequences by using a tokenizer associated with the generative model. The server then invokes the generative model to compute, for each decoding step, probability distributions over the token vocabulary. The server selects output tokens according to a decoding strategy, such as greedy decoding, beam search, or sampling with temperature, and iteratively constructs a natural language output sequence.

The server receives the generated natural language text from the generative AI model. The generated text may include an event title, a description of the event activities, a suggested time frame, and recommended products. For example, the generated text can be:
“Title: Discover New World Wines & Artisan Cheeses. Description: Invite the customer to an exclusive tasting of three new world wines paired with artisan cheeses, with a limited-time discount on featured bottles for attendees.”

The server applies a parsing process to the generated text to extract structured event information. The server uses pattern matching, keyphrase extraction, or shallow natural language parsing to detect fields such as an event name (for example, “Discover New World Wines & Artisan Cheeses”), an implementation period (for example, a specified date or timeframe inferred from phrases like “this Saturday evening” or “next weekend”), an implementation place (for example, a store described in association with a location term), and a target product group (for example, “new world wines” and “artisan cheeses”). The server normalizes these extracted values to standard formats and stores the resulting structured event record in relational tables indexed by user identification.

The server associates the structured event information with facility position information. The server may either link an event to a default facility associated with the user or determine one or more candidate facilities based on user profile and event content. The server stores an event record including the user identification, facility identifier, implementation period, and target product identifiers. By storing the structured event data rather than only free-form text, the server enables subsequent computation that is not possible with unstructured marketing content, such as efficient database queries, schedule checks, and spatial filtering based on facility coordinates.

The server acquires position information from the terminal. The terminal executes a position acquisition module that uses hardware such as a global positioning receiver or a network-based location service provided by the operating system of the terminal. The terminal periodically or on demand obtains coordinate data and transmits position information, including latitude, longitude, and timestamps, to the server via a secure communication channel. The terminal may additionally transmit a terminal identifier that the server maps to user identification.

The server receives the position information and compares it to facility position information stored in the storage device. The server calculates distances between the current user position and candidate facilities by computing, for example, great-circle distances based on the latitudes and longitudes. The server may use a geospatial extension in the database or perform numerical computations in the application layer. The server determines whether the distance is less than a predetermined threshold, such as 500 meters, and whether the current time is within the implementation period of the event. By using a numeric distance computation and time comparison, the server determines whether a particular structured event record satisfies technical conditions for notification.

The server generates a notification message when the structured event information is determined to be a notification target. The server constructs a message payload including an event summary, a description of the advantages to the user, and participation operation information such as a control or link that allows the user to accept or decline the event. The server uses the stored structured event information and stored natural language text to compose the message. The server transmits the notification message to the terminal by using a push notification service or another communication protocol.

The terminal receives the notification message by using an operating-system level notification framework. The terminal passes the payload to an application program. The terminal displays, on a graphical user interface, the event name, event description, store location, and participation options such as buttons labeled “Join”, “Remind me later”, and “Not interested”. The terminal may additionally display a map view using a map service software development kit, which renders a marker at the facility coordinates. The terminal thereby provides a concrete user interface element that is directly linked to the structured event record generated by the server.

The user operates the terminal to select a participation option. The user reads the event description on the screen and decides whether to attend the event. The user taps one of the buttons, and the terminal generates response information including participation information and identifiers of the event and the user. The terminal transmits the response information back to the server via a secure communication channel.

The server receives the response information, validates identifiers, and stores the response information in a dedicated response table in the database. The server records whether the user accepted, declined, or ignored the event, and associates this information with timestamps and event categories. The server uses this response information as learning data. In one embodiment, the server periodically aggregates response information and integrates it into the training dataset used to update the trained information processing model. The server adds features such as event type acceptance rates and cluster-based participation tendencies to the feature vectors.

The server retrains or fine-tunes the trained information processing model at scheduled intervals. The server includes user response labels, such as “joined wine tasting events” or “declined sports events,” in the training data. The server uses a loss function that penalizes misprediction of participation. The server executes a training loop in the tensor computation framework, computes gradients of the loss with respect to the model parameters, and updates the parameters to reduce prediction error. Through this continuous learning process, the model improves its ability to discriminate event types likely to be accepted by each user, which directly reduces the frequency of irrelevant promotions and the associated network and computation load.

The server also uses the response information to refine the prompt sentences. Before generating a new prompt sentence for a user, the server retrieves historical response statistics, such as the fraction of wine-related events accepted by the user and the fraction of sports-related events declined by the user. The server encodes these statistics as textual descriptions and appends them to the prompt template. For example, the server may generate a prompt sentence such as:
“Customer purchase history: wine, cheese. Past responses: the customer has previously joined wine tasting events and declined sports events. Please generate a personalized in-store promotion event focusing on wine and cheese that the customer is likely to attend.”

By incorporating structured behavioral feedback into the prompt, the server guides the generative AI model to produce more precise and contextually appropriate event descriptions. This feedback loop is not a mere automation of human writing but a machine-optimized chain in which each module is tuned to reduce redundancy in content generation, to exploit structured data, and to minimize misalignment between user interest and generated events.

The server thereby improves several aspects of computer technology. The server improves prediction accuracy of event relevance by using a neural network trained with explicit feedback loops, which reduces the number of unnecessary notifications and decreases bandwidth consumption and processing overhead on both server and terminal. The server improves data management by converting free-text generative outputs into structured records that can be indexed, queried, and filtered efficiently, enhancing database performance and enabling low-latency spatial and temporal decisions. The server improves computational efficiency and processing speed by preprocessing heterogeneous historical data into compact feature vectors and by executing optimized linear algebra operations in the tensor computation framework, reducing the number of conditional checks and manual template branches previously required in rule-based systems. The server reduces error and inconsistency in promotion messaging by systematizing the generation and reuse of prompt templates and by unifying the decision chain for event selection, text generation, and notification timing.

The terminal contributes to the technical effect by acting as a sensor and actuator for real-world context. The terminal supplies fine-grained position information that the server uses to perform precise distance-based filtering, which reduces broadcast-type communication and focuses processing on relevant users. The terminal renders dynamic user interfaces based on structured event information, enabling real-time updates without redesigning static screens for each campaign. In some embodiments, the terminal locally caches event information to reduce repeated server queries and supports offline viewing, thereby further decreasing network load.

The user acts as a source of labeled feedback through interactions with the terminal. The user's participation decisions become structured input for the learning process of the system. By incorporating these decisions into the trained model and the prompt sentence generation, the system produces a distinct technical behavior: the system dynamically adapts its internal weight parameters, feature distributions, and textual generation guidance in a way that no human operator could feasibly replicate at scale in real time. The system therefore performs more than a straightforward automation of human marketing tasks; it implements a specific, nonconventional pipeline involving model-based feature analysis, machine-constructed prompt sentences, generative AI text production, structured information extraction, and feedback-driven model refinement that leads to measurable improvements in processing accuracy, speed, and resource utilization.

The server can implement various alternative embodiments. In one embodiment, the trained information processing model is a recurrent neural network or a transformer-based encoder that takes as input sequences of purchases rather than aggregated features, thereby capturing order-dependent patterns. In another embodiment, the generative AI model is deployed on-premise and communicates with the main application through an interprocess communication interface rather than over an external network. In yet another embodiment, the server combines rule-based constraints with model outputs, for example by enforcing inventory-based conditions or regulatory constraints when selecting candidate events before prompt sentence generation. These variations all remain within the scope of using a trained model to analyze feature data, using automatically generated prompt sentences to drive a generative AI model, and using structured event information together with position information and response information to control notification behavior and model refinement.

Through these configurations, the server, terminal, and user cooperate within a technical framework in which generative AI capabilities are tightly integrated into data structures, model architectures, and communication control. This integration realizes a closed-loop, computer-implemented system that achieves improved technical performance in generating, selecting, and delivering personalized sales promotion event measures.

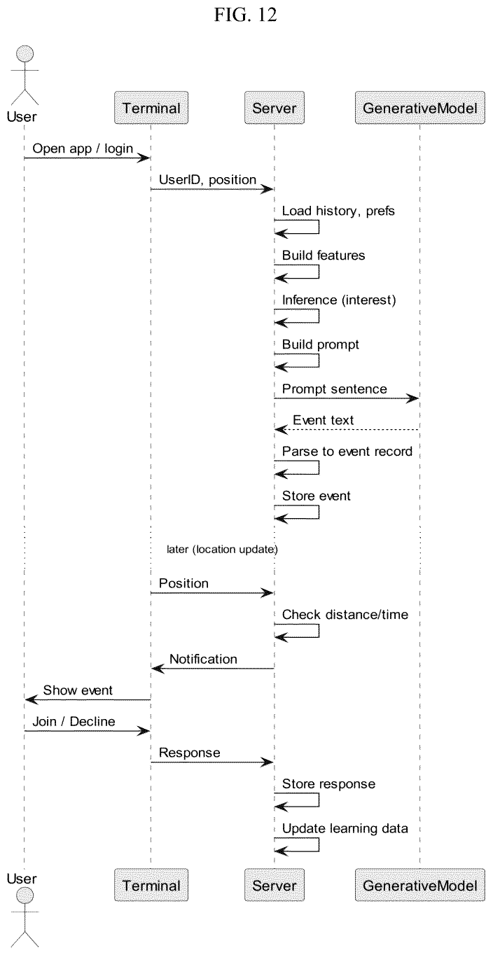

The following describes the processing flow using FIG. 12.

### Step 1:

The terminal transmits user identification information and, optionally, current position information to the server.
Input: user ID, optional device ID, optional latitude/longitude, timestamp.
Output: an HTTP request containing identification and optional position data.

The terminal executes an application that reads a stored user ID or device ID from its local storage, packages this information into a request message, and sends the message to the server via a secure communication protocol. If available, the terminal calls an operating-system location API to obtain latitude and longitude, attaches these values to the same request, and thereby initiates an event generation workflow on the server.

### Step 2:

The server acquires transaction history information and preference information from the storage device based on the received identification information.
Input: user ID (and/or device ID).
Output: raw transaction history records and preference records.

The server parses the incoming request, validates the user ID format, and uses a database driver to issue selection queries to a relational database. The server retrieves all purchase records associated with the user ID, including item identifiers, categories, timestamps, and amounts, and also retrieves preference records such as preferred categories or tags. The server converts the retrieved rows into in-memory data structures, such as lists or tables, which constitute the raw input for subsequent feature extraction.

### Step 3:

The server preprocesses the transaction history information and preference information and generates feature data.
Input: raw transaction history records and preference records.
Output: feature vectors or matrices including numerical feature values.

The server uses a data processing library to clean and transform the records. The server removes invalid or duplicate entries, aligns timestamps to a common format, and joins transaction records with preference tags by user ID. The server encodes categorical attributes such as product category into numerical indices or one-hot vectors, calculates aggregated metrics such as purchase frequency per category, average spending, and recency scores, and normalizes numerical fields to a predefined range. The server concatenates these numerical features into fixed-length feature vectors and stores them as a feature matrix ready for model inference.

### Step 4:

The server performs inference using the trained information processing model to obtain analysis results.
Input: feature vectors or matrices.
Output: interest scores or probability distributions over event categories.

The server loads a pre-trained neural network model from the storage device into memory, including its weight and bias tensors. The server feeds the feature vectors into the input layer of the model and performs successive matrix multiplications and activation function evaluations across hidden layers. The server computes an output vector whose elements represent the degree of interest of the user in different event categories. The server optionally applies a softmax or sigmoid function to convert raw scores into normalized probabilities, and then ranks or filters event categories based on these values.

### Step 5:

The server selects candidate event categories and key items based on the analysis results.
Input: interest score vector, feature data, transaction history information.
Output: a set of candidate event categories and representative items.

The server examines the interest scores and selects categories whose scores exceed a predetermined threshold or belong to the top N categories. For each selected category, the server inspects the user's transaction history to identify representative items, such as most frequently purchased products or products purchased most recently. The server forms an internal data structure that lists candidate event types (for example, “wine tasting”) and associated user-relevant items (for example, “red wine”, “cheese”), which will be reflected in the prompt sentence.

### Step 6:

The server generates a prompt sentence for the generative AI model.
Input: candidate event categories, representative items, analysis results, past response statistics (if available).
Output: a natural language prompt sentence.

The server retrieves a template for prompt generation from the storage device. The server fills the template with dynamic values such as the names of frequently purchased items, a textual summary of model-estimated interests, and, when available, historical participation tendencies. The server performs string concatenation and formatting to compose a coherent natural language prompt. For example, the server may generate:
“Customer purchase history: wine, cheese, premium snacks. Model-estimated interests: strong interest in new wine tasting events and cheese pairing sessions. Please generate a personalized in-store promotion event that will attract this customer.”

The server logs the generated prompt sentence and passes it to the generative AI interface module.

### Step 7:

The server transmits the prompt sentence to the generative AI model and obtains generated natural language text.
Input: prompt sentence.
Output: generated event description text.

The server encodes the prompt sentence into tokens using a tokenizer associated with the generative model and packages these tokens, or the raw text, into a request message. The server sends the request to a generative AI model endpoint via a communication interface.

The generative model computes probability distributions over tokens in a transformer or other language-model architecture and generates a sequence of tokens representing the event description. The server receives the generated sequence, decodes it back to a text string, and obtains a complete natural language description, such as a title and body text describing a personalized sales promotion event.

### Step 8:

The server extracts structured event information from the generated natural language text.
Input: generated event description text.
Output: structured event record including event name, implementation place, implementation period, and target product group.

The server analyzes the text using rule-based parsing, keyword detection, and pattern recognition. The server searches for phrases that resemble titles to identify an event name, detects time expressions such as dates or “this weekend” to infer an implementation period, looks for location-related phrases to map to known facilities, and identifies product-related terms to define a target product group. The server normalizes these extracted elements into structured fields and constructs an event record, which it stores in a database table linked to the user ID and, if determined, a facility ID.

### Step 9:

The server associates the structured event information with facility position information and stores it.
Input: structured event record, facility position information from storage.
Output: a stored event entry with user, facility, time, and product attributes.

The server queries the facility position table to obtain coordinates for candidate facilities and, based on the event content or user profile, selects one or more facilities at which the event may be implemented. The server populates the event record with the selected facility IDs and the implementation period, and inserts the record into an events table in the database. This stored event entry becomes part of a set of pending events that can be considered for notification when position information is available.

### Step 10:

The terminal acquires updated position information and sends it to the server.
Input: user's current geographic position (measured by the terminal).
Output: a position update request message to the server.

The terminal calls a location service API to read current latitude and longitude values from its positioning hardware. The terminal composes a message including the position coordinates, a timestamp, and a device identifier, and transmits the message to the server over a secure connection. The terminal may repeat this operation periodically or when the user's movement exceeds a specified distance threshold.

### Step 11:

The server evaluates proximity between the user and facilities linked to events.
Input: position information from the terminal, facility position information, stored event entries.
Output: a decision as to which event entries are notification targets.

The server retrieves the user's current position from the message and loads facility coordinates associated with that user's pending event entries. The server computes distances between the user position and each facility, for example using a great-circle distance formula, and compares each distance with a notification radius threshold. The server also checks whether the current time lies within the implementation period of each event. Based on these numerical comparisons, the server marks events that satisfy both spatial and temporal constraints as notification targets.

### Step 12:

The server generates notification messages for the selected events.
Input: structured event information for notification targets.
Output: notification message payloads.

The server constructs human-readable summaries using the event name, implementation period, facility name, and advantages such as discounts or exclusive access. The server also generates participation operation information, such as links or identifiers that the terminal can map to user interface actions. The server formats each notification as a payload containing title, body text, event ID, and control metadata. The server queues these payloads for transmission via a push notification service or another communication channel.

### Step 13:

The server transmits the notification messages to the terminal.
Input: notification message payloads, terminal identifiers.
Output: push notifications delivered to the terminal.

The server authenticates with a notification service and sends the payloads, specifying device tokens associated with the user's terminal. The server monitors responses from the notification service to confirm acceptance or detect errors. Successfully transmitted messages are flagged as sent in the event table, and the server may update counters for tracking notification history.

### Step 14:

The terminal receives the notification messages and displays event details to the user.
Input: notification payload from the server.
Output: a graphical user interface presenting event information and participation options.

The terminal's operating-system layer receives the push message and passes the payload to the installed application. The terminal parses the JSON or equivalent payload, extracts the event ID, title, body text, and control metadata, and stores them in a local data structure. The terminal then renders a notification banner or opens an in-app screen showing the event summary, implementation period, facility location (optionally on a map), and buttons such as “Join”, “Remind me later”, and “Not interested”.

### Step 15:

The user reviews the event information and selects a participation option.
Input: on-screen event details and buttons.
Output: a user decision (participate, postpone, or decline).

The user reads the event title and description, considers the time and place, and interacts with the terminal by tapping one of the presented buttons. This human action generates a selection signal within the terminal, indicating the chosen participation option. The terminal records this choice along with the associated event ID and user ID or device ID.

### Step 16:

The terminal sends response information including participation information to the server.
Input: user decision, event ID, user ID or device ID.
Output: a response message transmitted to the server.

The terminal constructs a response payload containing the identifiers and a status field indicating “join”, “decline”, “remind”, or another predefined code. The terminal sends this payload to a response-handling endpoint on the server via a secure protocol. The terminal optionally waits for acknowledgment from the server before marking the response as delivered in its local cache.

### Step 17:

The server records the response information and updates learning data.
Input: response payload including participation information, event ID, user ID.
Output: updated response records and learning dataset entries.

The server parses the response payload, verifies the consistency of the event ID and user ID, and inserts a record into a response table that stores the decision, timestamp, and event category. The server updates aggregated statistics, such as acceptance rates per event type and per user, and writes these values into a learning data store. The server later uses this learning data to retrain or fine-tune the trained information processing model and to adjust future prompt sentences by including participation tendencies, thus closing the feedback loop and improving the precision and efficiency of subsequent event generation and notification.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional event and promotion recommendation systems typically rely on static rules, coarse-grained purchase history, or manually designed questionnaires. Such systems suffer from several technical limitations in terms of how computing resources process, adapt, and utilize user information.

First, conventional systems often use fixed question scripts stored in a database, which are selected only by simple matching of user attributes or transaction history. A processor executing such logic cannot flexibly adapt question content to the current context or to subtle changes in user behavior, resulting in inefficient data acquisition and low information gain per interaction. This leads to unnecessary network traffic and processor load due to repeated or redundant interactions, without proportionate improvement in the quality of user preference data.

Second, many systems treat user answers as simple text strings or pre-defined options, and only perform basic keyword matching. From a computer-technology perspective, this underutilizes the expressive power of natural-language input and fails to structure the acquired data in a form suitable for subsequent automated processing. As a result, the internal data structures that represent user preferences remain shallow, and downstream modules such as recommendation engines or event-selection components cannot accurately compute relevance scores. This degrades the overall computational efficiency and effectiveness of the event-selection pipeline.

Third, conventional architectures generally separate question generation, answer analysis, and preference updating into loosely coupled subsystems that do not exploit a common representation or shared context. This lack of an integrated pipeline prevents the processor from updating user preference information in near real time and from feeding the updated information back into subsequent question generation. Consequently, the system cannot perform stepwise personalization within an ongoing dialogue, which causes suboptimal utilization of processor cycles and storage, and leads to delayed or imprecise event selection.

Fourth, existing systems rarely exploit modern generative AI models with carefully designed prompt sentences as a core computational mechanism within the server. In many cases, generative models, if used at all, are treated merely as auxiliary content generators without tight coupling to structured user profiles, dialogue history, and preference records stored in an information storage apparatus. This results in non-deterministic and poorly controlled outputs, which limits the reliability and repeatability of system behavior from a computing standpoint.

Accordingly, there is a need for a computer-implemented technique that: (i) systematically constructs and updates user profile information combining attribute information, transaction history information, and natural-language responses; (ii) uses prompt-controlled generative AI models as a programmable question-generation and analysis engine; (iii) performs integrated natural-language analysis to derive structured preference information suitable for automated event selection; and (iv) realizes a stepwise, feedback-driven dialogue loop that continuously refines stored user preference information and improves the precision and efficiency of selecting optimal event measures. The technical problem to be solved is to improve the way in which a processor, memory, and communication interfaces cooperate to acquire, structure, and exploit user preference data, thereby enhancing the computational performance, adaptability, and accuracy of an event-recommendation system.

The specific processing by the specific processing unit 290 of the data processing device 12 in Example 2 is realized by the following means.

The present invention provides a server comprising a processor and an information storage apparatus, the processor being configured to acquire, from the information storage apparatus, attribute information and transaction history information of a user based on identification information and generate profile information of the user based on the attribute information and the transaction history information; to create a prompt sentence including a description containing the profile information and question generation conditions, to input the prompt sentence into a generative AI model having a natural language processing function so as to request generation of an inquiry sentence, and to obtain the inquiry sentence output from the generative AI model; to cause an information terminal apparatus having a communication function to present the inquiry sentence to the user, and to obtain a free-form response sentence input by the user via the information terminal apparatus; to execute natural language analysis processing on the response sentence, the natural language analysis processing including at least one of morphological analysis, phrase extraction, semantic interpretation, and classification processing, and to extract preference information including interest-target category information and requested feature information from the response sentence; to update user preference information stored in the information storage apparatus based on the preference information; and to acquire candidate measure information from the information storage apparatus in which event information or promotion information is stored, calculate a relevance degree of the candidate measure information based on the updated user preference information, select optimal event measure information to be presented to the user based on the relevance degree, and instruct presentation of the optimal event measure information to the user via the information terminal apparatus. This enables the processor to implement an integrated, feedback-driven dialogue and recommendation pipeline in which generative AI-based question generation, structured natural-language analysis, and dynamic updating of stored preference information are tightly coupled, thereby improving the efficiency and precision of event selection, enhancing utilization of computational resources, and providing a technically improved computer system for adaptive event and promotion recommendation.

The term “processor” refers to a hardware execution unit, such as a central processing unit or a microcontroller, configured to execute machine-readable instructions for performing the operations described in the present specification and claims.

The term “information storage apparatus” refers to a hardware storage subsystem, such as a memory device or a database system, configured to store digital data including user attribute information, transaction history information, user preference information, event information, promotion information, and dialogue logs.

The term “identification information” refers to data, such as a user ID, account ID, device ID, or other unique identifier, that allows the system to distinguish one user from another and to access corresponding records in the information storage apparatus.

The term “attribute information” refers to structured data representing characteristics of a user, such as demographic attributes, geographic attributes, membership attributes, or other profile attributes stored in the information storage apparatus.

The term “transaction history information” refers to data representing past interactions or purchases of a user, including at least one of purchased item identifiers, purchase dates, quantities, prices, categories, and channels, stored in the information storage apparatus.

The term “profile information” refers to data derived by the processor from at least the attribute information and the transaction history information, and representing a summarized or structured characterization of the user for use in question generation, analysis, and recommendation.

The term “prompt sentence” refers to a text string or sequence of tokens generated by the processor and supplied as input to a generative AI model, the text string including at least one of the profile information, question generation conditions, and dialogue context, and constraining or guiding the behavior of the generative AI model.

The term “generative AI model” refers to a machine-learned model, such as a neural network-based language model, configured to generate natural-language text or other content in response to an input prompt sentence.

The term “inquiry sentence” refers to a natural-language question or interrogative text generated by the generative AI model based on the prompt sentence and obtained by the processor for presentation to the user.

The term “information terminal apparatus” refers to a user-facing computing device having at least an input interface, an output interface, and a communication interface, such as a smartphone, tablet, or personal computer, that exchanges data with the server and presents inquiry sentences and event information to the user.

The term “free-form response sentence” refers to natural-language text input by the user without constraint to predefined options, the text being received through the information terminal apparatus and transmitted to the server for analysis.

The term “natural language analysis processing” refers to a computational procedure executed by the processor on the free-form response sentence, the procedure including at least one of morphological analysis, phrase extraction, semantic interpretation, and classification processing, to derive structured information from natural-language input.

The term “preference information” refers to structured data generated by the processor through the natural language analysis processing, the data representing at least a user's interest-target category information, requested feature information, intent, or priority, and being suitable for storage and subsequent automated processing.

The term “interest-target category information” refers to data indicating at least one category or class of goods, services, or topics inferred from the free-form response sentence as being of interest to the user.

The term “requested feature information” refers to data indicating desired attributes, functions, or characteristics of goods, services, or events inferred from the free-form response sentence as being important to the user.

The term “user preference information” refers to data stored in the information storage apparatus that aggregates and represents the user's inferred preferences, including at least interest-target category information and requested feature information, and that is updated over time based on new analysis results.

The term “candidate measure information” refers to data representing possible event measures or promotion measures stored in the information storage apparatus, including at least identifiers, categories, feature tags, validity periods, and descriptive content.

The term “event information” refers to data representing planned or ongoing events, such as campaigns, fairs, demonstrations, or seminars, including at least scheduling information, target categories, and descriptive content.

The term “promotion information” refers to data representing marketing or sales measures, such as discounts, coupons, bundled offers, or loyalty benefits, including at least applicable products, conditions, and durations.

The term “relevance degree” refers to a numerical value or ordered measure computed by the processor indicating a degree of match between the candidate measure information and the updated user preference information, and used to rank or select event measures.

The term “optimal event measure information” refers to one or more items of candidate measure information selected by the processor based on the relevance degree as being most suitable for presentation to the user.

The term “dialogue history information” refers to data representing past interactions between the user and the system, including at least previously generated inquiry sentences, user responses, timestamps, and associated analysis results, stored in the information storage apparatus.

The term “emotion state information” refers to data indicating an estimated emotional state or affective condition of the user, such as satisfaction, interest, or hesitation, inferred by the processor from the free-form response sentence or other dialogue context by using natural language analysis processing.

The term “stepwise personalization” refers to a process in which the processor repeatedly generates inquiry sentences and analyzes response sentences while referencing the profile information and dialogue history information, thereby progressively refining the user preference information and adapting subsequent system outputs during an ongoing dialogue.

The term “presentation timing” refers to a time or temporal pattern determined by the processor for transmitting or displaying the optimal event measure information to the user via the information terminal apparatus.

In one embodiment, a server cooperates with at least one terminal and at least one user to implement the claimed system. The server includes a processor, a main memory, a non-volatile storage device, a network interface, and an information storage apparatus implemented, for example, by a relational database management system. The terminal includes a processor, a display, an input interface, and a wireless or wired communication interface. The user operates the terminal to view inquiry sentences and to input free-form response sentences.

The server uses general-purpose hardware such as an x86-compatible central processing unit, a main memory, and a solid-state drive. The server executes an operating system such as a UNIX-like operating system and runs one or more application programs implemented, for example, in a high-level programming language. The server further maintains an information storage apparatus realized by a database engine such as a relational database management system, in which user attribute information, transaction history information, user preference information, event information, promotion information, and dialogue history information are stored in multiple tables with defined schemas.

The server stores user attribute information in a table including fields such as user identifier, age band, geographic region, and membership grade. The server stores transaction history information in a table including fields such as record identifier, user identifier, item category code, item identifier, purchase timestamp, quantity, and price. The server associates each record with a user identifier to enable efficient retrieval by indexed queries. The server generates profile information by combining, aggregating, and normalizing this attribute information and transaction history information. The server represents the profile information internally as a structured record, for example, a key-value map containing category-level purchase frequencies, recency statistics, and inferred price sensitivity. By maintaining the profile information in this structured form, the server reduces repeated computation in subsequent processing and improves cache locality and memory usage.

The server implements a generative AI model as a separate module accessible via an application programming interface. In one embodiment, the server uses a transformer-based neural network language model pre-trained on a large corpus of natural-language sentences.

The generative AI model includes an embedding layer to convert input tokens to dense vectors, a plurality of self-attention layers arranged in a stack, and a projection layer to output token probabilities. The server stores model parameters, such as weight matrices and bias vectors, in a model storage region. The server configures the generative AI model with hyperparameters including the number of layers, attention heads, hidden dimension size, and a maximum sequence length. During training of the generative AI model, a training subsystem minimizes a cross-entropy loss function between predicted token distributions and ground-truth token sequences, and updates model weights by a gradient-based optimization algorithm such as stochastic gradient descent with adaptive learning rate. The server may perform further fine-tuning of the generative AI model using domain-specific training data consisting of question-answer pairs and event-selection contexts to reduce prediction error on the specific task. This training process modifies internal attention patterns and weight values, thereby improving the model's ability to generate inquiry sentences that maximize the information gain of each user interaction.

The server uses a prompt sentence to control the behavior of the generative AI model. The server constructs the prompt sentence by concatenating static template text with dynamic portions derived from the profile information and dialogue history information. The server performs text processing such as token normalization, punctuation handling, and character encoding conversion before transmitting the prompt sentence to the generative AI model. In one embodiment, the server generates a prompt sentence in the following form:
“You are an assistant helping a digital recommendation system understand a user's current interests. The user profile is as follows: Age: 30s. Region: urban. Frequently purchases devices in the smartphone and audio accessory categories. Recently purchased a wireless earphone. Generate one concise and polite question that elicits the user's most recent shopping interest. Answer only with the question.”

In another embodiment, the server generates an analysis-oriented prompt sentence in the following form:
“Analyze the following user answer and output structured information in the form: main_category, requested_features, intent. Answer: ‘I am looking for a new smartphone with a high-quality camera and long battery life.’”

The server supplies such prompt sentences as plain text input sequences to the generative AI model and receives generated text sequences as output. The server encodes both input and output via a defined tokenization scheme, such as sub-word tokenization, to ensure that the model can process rare or compound terms commonly appearing in product descriptions and user responses.

The server uses natural language analysis processing to convert free-form response sentences into structured preference information. The server executes a natural language processing pipeline including at least morphological analysis, phrase extraction, semantic interpretation, and classification processing. The server uses, for example, a morphological analyzer to segment the response sentence into tokens and to tag parts of speech. The server then applies a phrase-extraction algorithm that identifies noun phrases and verb-object pairs indicating product categories and desired features. The server further executes a classification algorithm, such as a neural network classifier or a gradient-boosted decision tree, to assign each response sentence to one or more interest-target categories and to infer requested feature information and user intent (for example, purchase intent or information-gathering intent).

The server represents the preference information as a structured data object, for example, a record including fields for category code, feature codes, inferred intent, and confidence scores. The server calculates confidence scores by applying a softmax function to the output of the classification model, and stores these scores in the preference record together with timestamps. The server then writes or updates corresponding entries in a user preference information table of the information storage apparatus. By storing preference information as normalized records with indexes on category and feature fields, the server enables efficient retrieval and aggregation during subsequent recommendation processing.

The server uses an event information table and a promotion information table in the information storage apparatus to store candidate measure information. Each event or promotion record includes a category code, one or more feature tags, a validity interval, and a base priority value. The server maintains additional indices that map category codes to event identifiers and feature tags to event identifiers. When the server updates the user preference information, the server performs a relevance-computation algorithm that combines the updated preference information with the candidate measure information. In one embodiment, the server calculates a relevance degree as a weighted sum of similarity scores between user category preferences and event categories, and between user feature preferences and event feature tags. The server may also include temporal decay factors based on the age of the user's transaction history and the proximity of event dates. By calculating the relevance degree in this manner, the server can sort candidate event measures and efficiently identify the optimal event measure information for each user.

The server utilizes a dialogue history information table to store generated inquiry sentences, user responses, analysis results, and event proposals for each interaction session. The server includes this dialogue history information in subsequent prompt sentences, allowing the generative AI model to generate context-aware inquiry sentences and to avoid redundant or low-value questions. For example, the server may construct a prompt sentence such as:
“The previous question to the user was: ‘What kind of electronic device are you most interested in purchasing next?’ The user answered: ‘I am interested in a high-end smartphone.’ Generate a follow-up question that asks about the most important feature for the user when choosing such a smartphone. Answer only with the question.”

The server thereby achieves stepwise personalization, in which each new inquiry sentence is conditioned on both the static profile information and the evolving dialogue history.

The terminal executes a client application that communicates with the server through a network protocol such as HTTPS. The terminal displays inquiry sentences and event information on the display and obtains user input through the input interface. The terminal transmits user-entered free-form response sentences to the server as text payloads. The terminal may perform basic preprocessing such as input validation and local encoding conversion, but does not perform the core natural language analysis or preference computation, which are executed by the server.

The user interacts with the terminal by reading the inquiry sentences and entering responses using a keyboard, touch interface, or voice-to-text conversion. The user reviews event information displayed on the terminal and may select specific events, request details, or indicate interest levels. The server logs these interactions as additional data points in the dialogue history information and user preference information.

The server achieves a technical improvement over conventional systems through the integrated design of the profile generation, prompt-controlled generative AI model, natural language analysis pipeline, structured preference storage, and relevance-based event selection. Because the server dynamically adjusts prompt sentences based on profile information and dialogue history information, the generative AI model generates inquiry sentences that focus on information not already present in the stored data. This reduces redundant questioning and lowers the number of interaction rounds required to reach a sufficient preference resolution, thereby decreasing overall network traffic and processing load. The server's use of a transformer-based neural network, with attention mechanisms that selectively weight different parts of the profile and dialogue context, allows the system to capture complex dependencies that conventional rule-based scripts cannot express without exponential growth in rule count.

The server also improves data management by maintaining a normalized, indexed representation of user preference information that is directly derived from analyzed natural-language responses. In contrast to simple keyword logs, the structured preference records support efficient relational joins and aggregation queries, enabling the processor to compute relevance degrees for large numbers of candidate events with reduced computational complexity. This improvement in data structure design, combined with the integrated analysis and update pipeline, results in faster response times when generating recommendations and reduces the memory footprint by avoiding ad-hoc, unstructured text storage.

The server further improves computational accuracy and reduces error by fine-tuning the generative AI model and classification models using domain-specific training data. During training, the server or a training subsystem uses a loss function that penalizes both category misclassification and feature-extraction errors. The server employs regularization techniques and data-augmentation methods, such as paraphrasing and synonym substitution, to increase robustness to varied user expressions. These training procedures adjust model weights to minimize the expected error on domain-specific tasks, leading to higher precision in identifying interest-target category information and requested feature information. As a consequence, the relevance computation for event selection yields more accurate rankings, and the probability of presenting irrelevant or low-value events is reduced.

The server applies decision rules that are not trivially replicable by manual human operators, because the rules internally depend on high-dimensional representations produced by the generative AI model and the classification models. The server evaluates similarity metrics in an embedding space, where user preferences and event descriptions are represented as vectors. The server measures cosine similarity or other distance metrics between these vectors to determine relevance degrees. Humans cannot directly operate on such internal vector representations, and conventional rule-based systems do not exploit this representation space. Therefore, the system relies on a non-conventional computational technique that improves matching quality and reduces misalignment between user interests and event measures.

The server may employ alternative embodiments in which the generative AI model is implemented as a recurrent neural network, a convolutional neural network for text, or a hybrid architecture combining attention layers with recurrent components. The server may also vary the natural language analysis algorithm to use different tokenization strategies, dependency parsing, or semantic role labeling, as long as the analysis produces structured preference information compatible with the storage and relevance-computation modules. The information storage apparatus may be implemented as a distributed database, an in-memory key-value store, or a column-oriented storage system, depending on performance and scalability requirements.

The server can be configured to control additional devices or systems based on the selected optimal event measure information. For example, the server can send control commands to digital signage controllers to dynamically update displayed event information when certain relevance thresholds are met. The server can trigger notifications to be pushed to terminals at specific presentation timings determined by combinations of user activity patterns and system load, thereby balancing computational resources and network usage. By coupling the internal preference computation with external device control and communication scheduling, the system achieves a concrete technological improvement in delivering adaptive content under resource constraints.

Through the above configurations and variations, the server, terminal, and user cooperate in a manner that enhances the internal operation of the computer system itself. The integration of profile-based prompt sentence generation, transformer-based generative AI modeling, structured natural language analysis, optimized data structures for preference storage, and algorithmic relevance computation yields improved processing speed, recommendation accuracy, and communication efficiency, and thereby provides more than a mere automation of a human mental process.

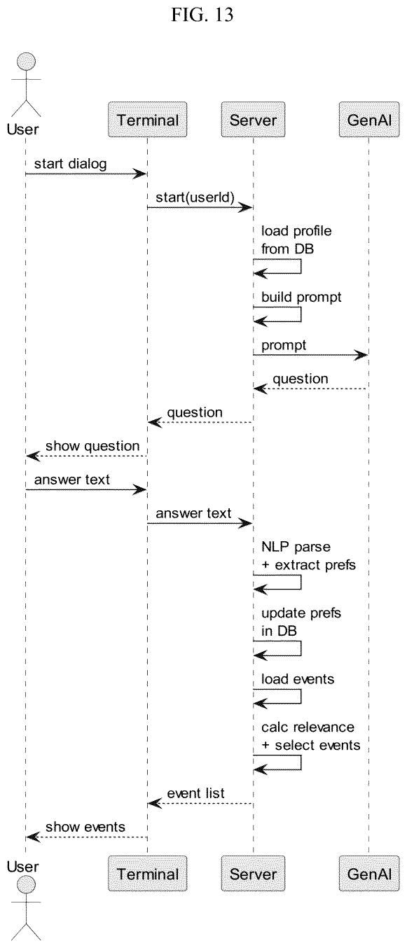

The following describes the processing flow using FIG. 13.

### Step 1:

The terminal sends, as input, a dialogue start request including a user identifier to the server via a network connection. The server receives the user identifier as input and executes a database query on the information storage apparatus to retrieve corresponding attribute information and transaction history information. The server performs data processing that includes filtering records by the user identifier, joining user tables and transaction tables, aggregating purchase counts per category, and computing recency statistics. The server outputs structured profile information, represented for example as a record including user attributes, category-level purchase frequencies, and recency values, and stores this profile information in working memory.

### Step 2:

The server takes the profile information as input and generates a prompt sentence for a generative AI model. The server concatenates static template text with dynamic fields derived from the profile information and, optionally, dialogue history information. The server performs string operations such as inserting age band, main purchase categories, and recent items into designated template positions, normalizing character encoding, and adding explicit instructions for the desired model behavior. The server outputs a completed prompt sentence, such as: “You are an assistant helping a digital recommendation system understand a user's current interests. The user profile is as follows: Age: 30s. Frequently purchases smartphones and audio accessories. Recently purchased a wireless earphone. Generate one concise and polite question that elicits the user's most recent shopping interest. Answer only with the question.”

### Step 3:

The server uses the prompt sentence as input to the generative AI model. The server tokenizes the prompt sentence into sub-word tokens, maps the tokens to embeddings, and forwards the embeddings through the layers of a transformer-based neural network including multi-head self-attention and feed-forward sublayers. The generative AI model performs matrix multiplications and nonlinear transformations to compute probability distributions over output tokens at each position. The server then decodes the output token sequence into text using a decoding strategy such as greedy decoding or top-k sampling constrained by a maximum token length and a temperature parameter. The server outputs an inquiry sentence, for example: “What kind of electronic device are you most interested in purchasing next?”

### Step 4:

The server takes the inquiry sentence as input and prepares a response message for the terminal. The server encapsulates the inquiry sentence in a structured message, attaches a session identifier and timestamp, and transmits the message through the network interface using a secure protocol. The terminal receives the message as input, parses the payload, and extracts the inquiry sentence text. The terminal performs display processing that includes rendering the text on the screen using a user interface framework, positioning the text in an appropriate layout, and activating an input field with an on-screen keyboard. The terminal outputs a displayed question and a ready state for user input.

### Step 5:

The user views the inquiry sentence on the terminal and generates, as input, a free-form response sentence by typing or speaking. The terminal captures the user input, converts it to text (for example, via keyboard events or speech-to-text conversion), and performs basic validation such as checking for non-empty content. The terminal then packages the response sentence together with the user identifier and session identifier and transmits this data to the server. The server receives the response sentence as input and stores it temporarily in a dialogue buffer for subsequent analysis. The server outputs a log entry associating the response with the corresponding inquiry sentence and user identifier.

### Step 6:

The server uses the response sentence as input to a natural language analysis pipeline. The server performs tokenization to split the sentence into tokens, executes morphological analysis to label parts of speech, and runs phrase extraction to identify noun phrases and verb-object patterns. The server then applies a semantic interpretation module, which may include a classification model or an additional generative AI model driven by an analysis-oriented prompt sentence such as: “Analyze the following user answer and output: main_category, requested_features, intent. Answer: ‘I am looking for a new smartphone with a high-quality camera and long battery life.’” Based on the computational output (for example, probability scores over categories and features), the server computes the most probable main category and feature set by selecting maximum-likelihood labels and applying thresholding. The server outputs structured preference information including at least an interest-target category (e.g., “smartphone”), requested feature codes (e.g., “high-quality camera”, “long battery life”), inferred intent, and associated confidence scores.

### Step 7:

The server takes the structured preference information as input and updates user preference information stored in the information storage apparatus. The server first reads existing preference records for the user by executing indexed queries on the preference table. The server then performs data operations such as merging new category interests with existing ones, updating interest levels using weighted averaging based on confidence scores and timestamps, and adjusting feature importance values according to predefined update rules. The server executes SQL insert or update statements within a transaction to write the modified preference records back to the database. The server outputs updated user preference information, which now reflects the latest response sentence and aggregated historical data.

### Step 8:

The server uses the updated user preference information as input to a relevance-computation module for event measures. The server queries event and promotion tables in the information storage apparatus to retrieve candidate measure information, including category codes, feature tags, base priority values, and validity periods. The server computes a relevance degree for each candidate by calculating similarity metrics between the user's category preferences and event categories, and between the user's requested feature vector and event feature vectors. The server may use operations such as vector dot products, cosine similarity, and weighted sums combining preference strengths and event base priorities, while applying temporal decay functions to older preference data. The server then sorts the candidates by the relevance degree and selects top-ranked items as optimal event measure information. The server outputs a ranked list of optimal event measures tailored to the user.

### Step 9:

The server takes the selected optimal event measure information as input and prepares presentation instructions for the terminal. The server formats event titles, descriptions, dates, and key features into a structured response, associates the response with a presentation timing determined by system rules (for example, immediate display or delayed notification), and transmits the response via the network interface. The terminal receives the event measure list as input, parses it, and renders each event on the display as a selectable item with descriptive text and actionable controls. The terminal outputs a user interface showing personalized event proposals.

### Step 10:

The user observes the presented optimal event measures on the terminal and provides, as input, further interaction signals such as selecting an event, requesting details, or dismissing proposals. The terminal captures these interactions and sends corresponding event-interest or event-rejection messages to the server. The server receives these messages as input and records them in the dialogue history information and, optionally, adjusts preference weights or event relevance rules based on observed user behavior. The server outputs updated dialogue history records and refined model signals that can be used as additional context in subsequent prompt sentences and relevance computations, thereby closing the feedback loop and improving future processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems typically rely on static profiling techniques that analyze historical transaction data and coarse preference indicators to generate product or event recommendations. Such systems generally execute a fixed sequence of database queries and rule-based filters on server hardware and present the resulting items to a user terminal. These architectures exhibit several technical limitations when deployed in modern interactive environments.

First, conventional systems treat user inputs as isolated queries and do not maintain a rich, machine-usable dialog history structure that continuously aggregates fine-grained signals from natural language input and emotional state information. As a result, the internal data structures that represent the user state remain sparse and outdated, leading to low-quality and poorly timed recommendations. This degrades the effectiveness of the overall computation pipeline and results in frequent, redundant database accesses without commensurate gains in relevance.

Second, conventional systems do not integrate generative artificial intelligence models into the core control flow of the recommendation engine in a systematic way. In particular, existing architectures do not construct and manage prompt sentences as first-class control objects that encode user context, dialog history, preference information, and emotional state information in a machine-interpretable format. Without such prompt orchestration, generative models are either not used or are invoked in an ad hoc manner, which yields unstable outputs and forces the server to perform additional post-processing and filtering operations, increasing computational overhead and latency.

Third, many existing systems perform sentiment or emotion analysis as an auxiliary function, disconnected from the main recommendation logic. The emotion analysis results are typically stored as passive metadata but are not actively injected into the prompt sentences or into the decision logic that determines content selection, ordering, or message phrasing. Consequently, the system does not exploit the emotional state information to adapt its internal processing pipeline, such as ranking algorithms or template generation, with the result that the communication flow remains rigid and insensitive to user state, and server resources are spent delivering proposals that are not aligned with the user's current condition.

Fourth, conventional push-notification mechanisms on information processing terminals simply deliver static messages prepared offline or by generic templates. Server-side logic rarely captures detailed viewing history information and selection history information in a form that closes the loop back into the core recommendation pipeline. This lack of feedback integration prevents the system from updating purchase history information and preference information in a fine-grained and event-driven manner, thereby limiting the capability to tune model behavior and data structures based on actual user responses.

From the viewpoint of computer technology, these limitations manifest as inefficient use of processing resources, suboptimal organization and updating of state data structures, and inadequate coordination between natural language processing components, emotion analysis components, and generative model components. The result is that server-side computation pipelines remain fragmented and are not configured to adaptively reconfigure prompt sentences, generative model calls, and proposal adjustment operations in response to live dialog and emotion data.

Accordingly, there is a need for a computer-implemented system that technically improves the way a processor manages dialog history information, emotional state information, and recommendation generation. In particular, there is a need for a server-side architecture in which the processor (i) acquires and structures user input into dialog history information, (ii) updates purchase history information and preference information on the basis of natural language analysis and emotion estimation, (iii) generates and manages prompt sentences as machine-usable control artifacts for operating a generative AI model, and (iv) uses feedback from user viewing history information and selection history information obtained through push distribution to iteratively refine learning data used in subsequent prompt generation and proposal generation. Such an architecture provides a concrete improvement in the functioning of a computer system itself, by reorganizing the flow of data and control signals among databases, emotion analysis components, and generative AI models to produce more relevant outputs with more efficient use of computational resources.

The specific processing by the specific processing unit 290 of the data processing device 12 in Application Example 2 is realized by the following means.

The present invention provides a server comprising a processor and a memory storing instructions, the instructions causing the processor to execute user input acquisition processing to receive input information from a user via an information processing terminal, profile update processing to analyze dialog history information and user attribute information including the input information and to extract or update purchase history information and preference information, emotion estimation processing to specify emotional state information on the basis of voice information or character information included in the input information, prompt generation processing to generate a prompt sentence on the basis of the purchase history information, the preference information, and the emotional state information, proposal generation processing to operate a generative AI model by using the prompt sentence as input and to cause the generative AI model to generate proposal information including recommended product information, recommended event information, or recommended campaign information, proposal adjustment processing to adjust content or presentation order of the proposal information in accordance with the emotional state information, notification processing to transmit the proposal information as notification information to the information processing terminal and to cause the information processing terminal to present the proposal information to the user, and learning data update processing to record response information from the user and the emotional state information as dialog history information and to reflect the dialog history information in subsequent generation of the prompt sentence and subsequent generation of the proposal information. This enables the computer system to internally structure and update user state as dialog history information in real time, to integrate emotional state information into prompt sentences supplied to the generative AI model, to dynamically adapt proposal generation and adjustment operations within the server-side computation pipeline, and to close a feedback loop using viewing history information and selection history information obtained via push distribution so that the underlying data structures and model behavior are iteratively improved in a technically efficient manner.

The term “processor” refers to a hardware computing unit or a collection of hardware computing units configured to execute machine-readable instructions, including a central processing unit, a graphics processing unit, or any other programmable processing circuitry.

The term “memory” refers to a hardware storage component configured to store machine-readable instructions and data for access by the processor, including volatile storage, non-volatile storage, or a combination thereof.

The term “user” refers to a human operator who interacts with the system through an information processing terminal by providing input information and receiving proposal information.

The term “information processing terminal” refers to an electronic device configured to communicate with the server, to present information to the user, and to acquire input information from the user, such as a smartphone, a tablet, a wearable device, or a general-purpose computing device.

The term “input information” refers to data received from the user through the information processing terminal, including text input, voice input, selection input, or any combination thereof.

The term “dialog history information” refers to structured data representing a sequence of interactions between the user and the system, including questions presented to the user, answers provided by the user, associated timestamps, and related emotional state information.

The term “user attribute information” refers to data describing characteristics of the user, including demographic information, account information, preference information, and any other profile data stored by the system.

The term “purchase history information” refers to data indicating past transactions or acquisition activities of the user, including purchased items, services, events, or campaigns, together with associated metadata such as time, location, and amount.

The term “preference information” refers to data representing inferred or explicit user interests, likes, dislikes, or inclination toward categories of items, services, events, or campaigns, derived from purchase history information, dialog history information, or other signals.

The term “profile update processing” refers to operations executed by the processor to analyze dialog history information and user attribute information and to extract or update purchase history information and preference information.

The term “voice information” refers to audio data representing spoken utterances of the user, captured by a microphone of the information processing terminal or an associated device.

The term “character information” refers to text data representing user input or system-generated content, including transcribed voice information or directly entered text.

The term “emotional state information” refers to data indicating an estimated emotional condition of the user, including categories such as joy, sadness, stress, neutrality, or other affective states, optionally associated with confidence scores or intensity levels.

The term “emotion estimation processing” refers to operations executed by the processor to analyze voice information, character information, or both, in order to compute emotional state information.

The term “acoustic feature information” refers to numerical or symbolic descriptors derived from voice information, including pitch, energy, spectral characteristics, prosody, or other audio features useful for emotion estimation.

The term “prompt sentence” refers to a text structure generated by the processor that encodes instructions, constraints, and context information, including purchase history information, preference information, and emotional state information, and that is supplied as input to a generative AI model.

The term “prompt generation processing” refers to operations executed by the processor to assemble and generate a prompt sentence based on purchase history information, preference information, emotional state information, and optionally dialog history information or user attribute information.

The term “generative AI model” refers to a machine learning model configured to produce output data, such as text, in response to input data, including large language models, neural network-based generation models, or any other artificial intelligence model capable of generating proposal information from a prompt sentence.

The term “proposal information” refers to data generated by the generative AI model and processed by the system that includes recommended product information, recommended event information, recommended campaign information, explanatory text, or any combination thereof suitable for presentation to the user.

The term “recommended product information” refers to proposal information specifying goods or services suggested to the user, including identifiers, descriptive text, and optionally pricing or availability data.

The term “recommended event information” refers to proposal information specifying events suggested to the user, including identifiers, descriptive text, schedules, locations, or access methods.

The term “recommended campaign information” refers to proposal information specifying promotional activities suggested to the user, including discounts, coupons, special offers, or loyalty programs.

The term “proposal generation processing” refers to operations executed by the processor to operate the generative AI model using a prompt sentence and to obtain proposal information including recommended product information, recommended event information, or recommended campaign information.

The term “proposal adjustment processing” refers to operations executed by the processor to modify content, ranking, or presentation order of proposal information on the basis of emotional state information, dialog history information, or other contextual data.

The term “notification information” refers to data representing proposal information and associated metadata, formatted for delivery from the server to the information processing terminal for presentation to the user.

The term “notification processing” refers to operations executed by the processor to transmit notification information to the information processing terminal and to cause the information processing terminal to present the proposal information to the user.

The term “push distribution function” refers to a communication mechanism by which the server initiates delivery of notification information to the information processing terminal without requiring a polling request from the terminal, including any push notification infrastructure provided by a communication platform or operating system.

The term “response information” refers to data indicating user reactions to proposal information, including explicit selections, acceptances, rejections, dismissals, or additional input provided in response to proposals.

The term “viewing history information” refers to data representing the user's viewing behavior with respect to proposal content, including which notifications were opened, how long content was viewed, and which items were inspected.

The term “selection history information” refers to data representing the user's explicit selections or actions taken with respect to proposal content, including item selections, event registrations, or campaign activations.

The term “learning data update processing” refers to operations executed by the processor to record response information, viewing history information, selection history information, and emotional state information as dialog history information and to update purchase history information and preference information for use in subsequent prompt generation processing and proposal generation processing.

In one embodiment, a server, a terminal, and a user cooperate to implement the present invention.

The server includes a processor, a memory, a network interface, and one or more storage devices.

The terminal includes a processor, a memory, a display, an input device such as a touchscreen or keyboard, a microphone, a camera, and a network interface.

The user interacts with the terminal to provide input information and to receive proposal information.

The server executes a program stored in the memory.

The program is implemented, for example, using a general-purpose programming language such as a scripting language or a compiled language, and runs on a general-purpose operating system.

The server accesses a relational database system such as a structured query language database server (e.g., MySQL-type or PostgreSQL-type system).

The server further accesses one or more machine learning frameworks (for example, a deep learning framework such as TensorFlow-type or PyTorch-type framework) and a natural language processing library (for example, an NLP library such as a spaCy-type framework).

The server can also call external cognitive services for speech recognition or emotion analysis, such as a generic cloud speech-to-text service, a generic emotion analysis service, or a tone analysis service, as needed.

The server stores in the storage device a plurality of data structures, including at least:
(1) a user table that stores user attribute information;
(2) a purchase history table that stores purchase history information;
(3) a preference table that stores preference information;
(4) a dialog history table that stores dialog history information;
(5) a proposal table that stores proposal information;
(6) an emotion history table that stores emotional state information; and
(7) an event log table that stores viewing history information and selection history information related to proposals and notifications.

The server, in one embodiment, represents dialog history information as a sequence of dialog turns, each dialog turn including fields such as a dialog identifier, a user identifier, a timestamp, a question text, an answer text, extracted keyword features, a referenced prompt sentence identifier, and associated emotional state information.

The server represents purchase history information and preference information using normalized relational schemas and, in some variants, using vector representations stored as binary data in the database or in a dedicated feature store.

The server includes a generative AI model as part of the proposal generation processing.

In one embodiment, the generative AI model is implemented as a large-scale neural network with a transformer architecture.

The transformer includes an encoder-decoder or decoder-only structure with multi-head self-attention layers, position-wise feed-forward layers, layer normalization units, and residual connections.

The server stores trained model parameters (weights and biases) in the storage device or in a separate model storage, and loads them into memory at runtime.

The server configures the number of layers, the number of attention heads, the dimensionality of intermediate representations, and other hyperparameters according to available computational resources.

The server trains the generative AI model in an offline phase using a training dataset that includes historical dialog data, purchase history, preference labels, and annotated emotional state information.

The server defines a loss function for the training process.

In one embodiment, the loss function includes a cross-entropy term for next-token prediction in text generation and an auxiliary loss term for preference-aligned classification or ranking.

The server updates the model parameters using a stochastic gradient-based optimization algorithm, such as stochastic gradient descent with momentum or an adaptive learning rate method.

The server optionally employs regularization techniques such as dropout in attention layers, weight decay, or label smoothing to improve generalization.

The server may perform data augmentation by paraphrasing training sentences using a separate text transformation model or by injecting synthetic emotional context, in order to increase robustness of the generative AI model to variable wording and emotional nuances.

The server, in one embodiment, does not merely automate human selection operations, but changes the internal data processing structures and algorithmic flow in a way that improves computer functionality.

The server organizes user state data into dialog history information and embeds emotional state information directly into prompt sentences and intermediate feature vectors.

The server thereby reduces redundant database queries and post-processing filters compared to conventional recommendation pipelines.

The server encodes rich user context into compact vector representations and into structured prompt sentences before calling the generative AI model.

As a result, the server reduces the number of model calls needed to reach an acceptable recommendation quality, which leads to improved throughput and reduced latency per recommendation cycle.

The server also improves accuracy by conditioning recommendations on emotion-aware features and by learning a mapping between emotional patterns and outcome success (e.g., click-through, acceptance), which is not feasible with simple rule-based systems.

The terminal, in one embodiment, operates as an information processing terminal such as a smartphone, tablet, or wearable smart glasses.

The terminal presents user interface screens to the user, transmits user input information to the server, and receives proposal information and notification information from the server.

The terminal uses an operating system's networking stack to send and receive data over a communication network.

The terminal also uses a user interface framework to render question texts, answer input boxes, buttons, lists of proposals, and notification pop-ups.

In a variant where the terminal is smart glasses, the terminal uses a heads-up display to show short suggestion texts to a store staff and uses an integrated camera and microphone to acquire user facial images and voice data.

The user interacts with the terminal by entering text, speaking into the microphone, tapping or clicking user interface components, and responding to push notifications.

The user's behavior, including which proposals the user views, which items the user selects, and which proposals the user ignores, is reflected in viewing history information and selection history information.

The server uses this information as feedback to iteratively refine future prompt sentences and proposal information.

The server, in one specific example, uses a natural language processing library to analyze user answer text.

When the user enters a sentence such as “I want to buy new wireless headphones for music,” the server tokenizes the sentence, determines part-of-speech tags, and identifies noun phrases.

The server may extract key phrases such as “wireless headphones” and “music.”

The server then constructs a prompt sentence for the generative AI model, such as:
“Extract main product categories and preference tags from: ‘I want to buy new wireless headphones for music.’ Return the category and a list of preference tags.”

In this variant, the generative AI model returns a classification result, which the server stores in the preference table.

The server also constructs higher-level prompt sentences that drive recommendation generation.

In one example, the server generates the following prompt sentence:
“User profile: prefers music and audio equipment; latest intent: wants new wireless headphones; emotion: joy.

Available options:
1) Noise-cancelling wireless headphones with 15% discount,
2) Sports in-ear wireless earphones,
3) Ticket to an online live music event.

Generate a response in which you recommend the most suitable items for this user and briefly explain why.”

The generative AI model, in response, outputs a textual description that includes a recommended item list and explanatory text.

The server converts this output into structured proposal information, assigns identifiers for each recommended item, and stores the proposal in the proposal table.

The server, in an emotion-aware variant, uses a voice analysis service or a text-based emotion analysis service.

When the user speaks into the microphone, the terminal captures an audio stream.

The server or the terminal sends the audio to a speech-to-text service to produce character information.

The server then extracts acoustic feature information such as pitch contour, intensity, and spectral features.

The server feeds these features into an emotion classification model, which can be implemented as a neural network with convolutional or recurrent layers specialized for audio processing.

The server combines this audio-based emotion estimate with text-based sentiment scores from an NLP model.

The server then normalizes the result into emotional state information, e.g., “joy with confidence 0.82.”

The server embeds this emotional state information into the prompt sentence given to the generative AI model.

For example, the server may generate a prompt sentence:
“User text: ‘I want to buy new headphones.’
Detected emotion: joy (0.8).

Summarize the user's emotional state and interest in one sentence suitable for downstream recommendation logic.”

The generative AI model then returns a summarizing sentence that the server attaches to the user's dialog history information.

By embedding emotional state information and summarized context into a single prompt sentence, the server reduces the complexity of downstream decision logic.

Instead of relying on multiple disjoint rules, the server centralizes the context representation in the prompt sentence and uses the generative AI model to produce context-aware outputs.

This reduces the number of conditional branches in the server code and diminishes the need for repeated SQL joins to reconstruct context, which improves processing speed and scalability.

The server, in a push-notification variant, integrates with a generic push distribution infrastructure.

The server encodes notification information into a payload that includes a title, a body text, and an optional deep link to a proposal detail screen.

The server constructs a prompt sentence for the generative AI model to generate notification text, for example:
“User is interested in classical music and high-end headphones.

Draft a concise push notification title and body to invite the user to a classical concert and offer a discount on premium headphones.”

The generative AI model returns candidate texts, and the server selects them and sets them in the payload.

The server then sends the payload to the push distribution infrastructure, which delivers it to the terminal.

The terminal displays the notification in the operating system's notification area. When the user opens the notification, the terminal triggers a callback to the server, and the server updates viewing history information and selection history information in the event log table.

The server uses learning data update processing to adjust preference weights or to create new preference tags on the basis of which notifications led to user actions.

Over time, this feedback loop improves the model's ability to match proposals to user states, again without simply replicating human decision rules but by exploiting learned statistical patterns.

In a store-support embodiment, the terminal is implemented as smart glasses worn by a staff member.

The terminal captures images of a visiting customer's face and transmits sample frames to the server.

The server uses a generic face recognition module, implemented maybe by a convolutional neural network trained on facial feature embeddings, to match the face against stored feature vectors in a customer face index table.

When a match is found, the server retrieves purchase history information and preference information for that customer.

The server may then generate a prompt sentence such as:
“Customer profile: prefers premium wine, attended previous tasting event.
Current conversation: customer is asking about weekend plans.
Emotion: mild joy.
Generate one polite sentence for staff to say, suggesting a wine-tasting event this weekend.”

The generative AI model produces a concise recommendation phrase, which the server sends to the smart glasses.

The terminal displays the phrase in a short text overlay, allowing the staff to speak it naturally to the customer.

This configuration alters the technical operation of the terminal-display pipeline by enabling real-time, context-aware text rendering in response to dynamically generated prompt sentences, rather than static templates.

The server architecture in these embodiments yields technical effects that go beyond business logic automation.

Because dialog history information, emotional state information, and preference information are stored in structured and vectorized forms, the server can perform efficient indexing and retrieval, limiting full-table scans and reducing disk I/O.

Because prompt sentences aggregate necessary context in a single text block and because the generative AI model is conditioned on this comprehensive prompt sentence, fewer model invocations are needed, and less manual rule-based filtering is performed.

This reduces CPU usage and network bandwidth between the server and any external model-serving components.

Additionally, the use of feature-rich emotional state information improves the accuracy of recommendations, as measured by objective metrics such as click-through rate or engagement duration, compared with systems that do not incorporate such features.

The server further improves robustness and reduces computational overhead by using non-conventional processing sequences.

For example, the server can first perform a lightweight NLP-based feature extraction to filter candidate products or events in the database, before calling the generative AI model.

The server thus restricts the set of options that the generative AI model has to consider, reducing the length and complexity of prompt sentences and the subsequent output to be parsed.

By combining rule-based pre-filtering with generative post-formatting in this specific sequence, the server reduces the generative AI model's burden and improves latency, while maintaining or improving recommendation quality.

Alternative embodiments are possible.

In one alternative, the generative AI model is not a transformer but a recurrent neural network with long short-term memory units, particularly in resource-constrained environments.

In another alternative, the emotion estimation model is integrated into the generative AI model as a multitask architecture, where some layers are shared and output heads produce both text tokens and emotion class probabilities.

In yet another embodiment, the server uses vector databases or approximate nearest-neighbor search structures to store and retrieve preference vectors and dialog context vectors, further increasing retrieval speed for similar users or similar situations.

In all of these embodiments, the server, the terminal, and the user cooperate in a system where the server manages precise data structures for dialog history, emotional state, purchase history, and preferences;
where the server constructs and uses prompt sentences as explicit control artifacts for a generative AI model;
and where the server closes a feedback loop by using viewing history information and selection history information to update learning data.

This architecture improves the functioning of the underlying computer system by reorganizing internal data flows, reducing redundant computations, and enabling emotion-aware, context-rich output generation that cannot be achieved by straightforward manual replication of human decision-making.

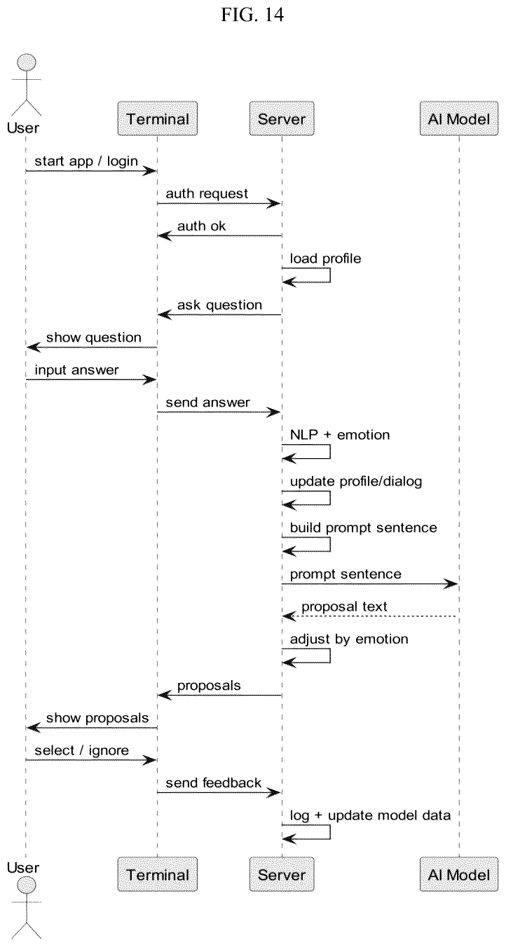

The following describes the processing flow using FIG. 14.

### Step 1:

Server initializes system resources.

Server loads configuration information from memory as input, including database connection parameters, model endpoints, and feature extraction settings.

Server opens connections to a relational database system and loads generative AI model parameters into memory, and initializes natural language processing and emotion estimation modules as output.

Server allocates internal data structures for dialog history information, purchase history information, preference information, and emotion history information in working memory.

### Step 2:

Terminal initializes a user interface.

Terminal uses stored application configuration and display capabilities as input.

Terminal renders a login or start screen with input fields and buttons as output.

Terminal prepares UI components for capturing text input, voice input, and user selections.

### Step 3:

User initiates a session.

User provides login information or session start commands as input through the terminal.

User touches or clicks a login button or a “Start” button, which triggers transmission of the input to the server as output.

### Step 4:

Server authenticates the user and loads initial profile.

Server receives login credentials or a session token from the terminal as input.

Server executes database queries on a user table and a purchase history table, compares a hashed password or token, and constructs a user profile object that contains user attribute information, purchase history information, and preference information as output.

Server stores the profile object in memory and returns a session identifier to the terminal.

### Step 5:

Terminal acknowledges the authenticated session.

Terminal receives the session identifier and basic user profile summary from the server as input.

Terminal stores the session identifier locally, updates the display to show a welcome screen, and transitions into an interactive mode as output.

### Step 6:

Server prepares a question for the user.

Server takes the user profile object and recent dialog history information as input.

Server selects relevant attributes (for example, most recent purchases, missing preference fields) and constructs a control structure that specifies what type of question to ask as output.

### Step 7:

Server generates a prompt sentence for question creation.

Server uses the selected attributes and dialog context as input.

Server concatenates these elements into a natural language prompt sentence, such as:
“User history: frequently buys audio equipment. Generate one short question to ask about the user's next purchase interest.”

Server outputs this prompt sentence and passes it to the generative AI model interface.

### Step 8:

Server calls the generative AI model to obtain a question.

Server uses the prompt sentence from Step 7 as input.

Server sends the prompt sentence to the generative AI model, which processes the text through multiple transformer layers and produces a question string; the server receives the generated question as output.

Server stores the question text and an associated question identifier in the dialog history table.

### Step 9:

Server sends the question to the terminal.

Server takes the generated question and session identifier as input.

Server constructs a response message that includes the question text and question identifier and transmits it to the terminal as output.

### Step 10:

Terminal displays the question to the user.

Terminal receives the question text and question identifier from the server as input.

Terminal updates the current UI screen, renders the question text in a text area, and displays input fields or a microphone button as output.

### Step 11:

User provides an answer.

User reads the question on the terminal as input.

User enters a textual answer via keyboard or speaks into the microphone, and confirms submission; the resulting text or audio is captured by the terminal as output.

### Step 12:

Terminal sends the user's answer to the server.

Terminal takes the answer text or recorded audio, together with the session identifier and question identifier, as input.

Terminal packages these values into a message object and transmits it to the server as output.

### Step 13:

Server converts voice input to text when necessary.

Server receives an audio stream and metadata from the terminal as input.

Server calls a speech-to-text component, which computes spectrograms and applies an acoustic model and language model to produce transcribed text as output.

Server replaces the audio data with the transcribed text for further processing.

### Step 14:

Server performs natural language analysis of the answer.

Server takes the answer text as input.

Server uses a natural language processing module to tokenize the text, tag parts of speech, and detect phrases; the server extracts key terms and product category indicators as output.

Server may identify tokens such as “wireless,” “headphones,” and “music” and store them as keyword features in memory.

### Step 15:

Server structures preference information.

Server uses the extracted keywords, existing preference information, and user attribute information as input.

Server combines these signals, applies classification rules or a lightweight model, and constructs structured preference data such as categories and tags as output.

Server updates records in the preference table and, if necessary, adds new entries in an intended-product structure.

### Step 16:

Server estimates an emotional state from text and voice.

Server takes answer text, and optionally acoustic feature information derived from voice, as input.

Server computes sentiment scores from the text and analyzes acoustic features such as pitch and intensity, and then fuses these values using a trained classifier to produce emotional state information as output (for example, “joy, score 0.8”).

### Step 17:

Server updates emotion history.

Server uses the emotional state information, user identifier, and question identifier as input.

Server inserts a new record into the emotion history table that includes the estimated emotion, confidence, and timestamp as output.

### Step 18:

Server updates dialog history.

Server takes the question identifier, answer text, extracted keywords, and emotional state information as input.

Server writes a dialog turn record into the dialog history table, linking the question and answer pair, and stores pointers to associated profile and emotion entries as output.

### Step 19:

Server aggregates contextual state for recommendation.

Server uses updated purchase history information, preference information, dialog history information, and emotional state information as input.

Server retrieves recent records from multiple tables, merges them into a unified context object that describes the current user state, and keeps this context object in memory as output.

### Step 20:

Server generates a prompt sentence for recommendation.

Server uses the context object, including current preferences and emotional state, as input.

Server constructs a prompt sentence such as:
“User profile: prefers music and audio equipment; latest intent: wants new wireless headphones; emotion: joy. Available options: 1) Noise-cancelling wireless headphones with discount, 2) Sports in-ear earphones, 3) Online live music event. Generate a response recommending suitable items and explain why.”

Server outputs this prompt sentence and passes it to the generative AI model.

### Step 21:

Server calls the generative AI model to generate proposal information.

Server uses the recommendation prompt sentence as input.

Server sends the prompt sentence to the generative AI model, which transforms the input through attention-based computations and outputs a recommendation text; the server receives this recommendation text as output.

Server parses the recommendation text to identify recommended items and explanation segments.

### Step 22:

Server converts recommendation text to structured proposal information.

Server uses the recommendation text and catalog information from a product/event database as input.

Server performs string matching or classification to map described items to internal item identifiers and assembles structured proposal information with item IDs, titles, and description texts as output.

### Step 23:

Server adjusts proposal information based on emotional state.

Server uses the structured proposal information and emotional state information as input.

Server reorders items, filters some items, or modifies explanation tones when the emotion indicates stress or excitement, and produces an adjusted proposal list as output.

### Step 24:

Server prepares notification information.

Server takes the adjusted proposal list and session identifier as input.

Server formats the data into a response payload or notification payload that contains titles, short messages, and optional links, and outputs this payload toward the terminal or a push distribution infrastructure.

### Step 25:

Terminal receives and displays proposals in the application.

Terminal receives the proposal payload from the server as input.

Terminal constructs screen elements such as lists or cards for each recommended item and renders titles, images, and descriptions on the display as output.

### Step 26:

User reviews and selects proposals.

User views the recommended items on the terminal screen as input.

User scrolls through the list and taps or clicks on items of interest, resulting in selection signals that are sent back to the server as output.

### Step 27:

Server records viewing history and selection history.

Server takes view events and selection events from the terminal as input.

Server inserts or updates event log records that capture which proposals were displayed, which were opened, and which were selected, and stores these histories in the event log table as output.

### Step 28:

Server performs learning data update processing.

Server uses event log records, updated preference information, and emotional state information as input.

Server adjusts internal preference scores, updates dialog history entries with outcome labels, and optionally generates training samples for later model retraining as output.

### Step 29:

Server refines future prompt generation parameters.

Server takes aggregated statistics from previous interactions and their outcomes as input.

Server updates configuration parameters that control prompt sentence templates, such as preferred question patterns and notification wording, and stores these updated parameters for subsequent sessions as output.

### Step 30:

Terminal optionally receives push notifications.

Terminal receives push notification payloads from a push distribution infrastructure as input.

Terminal displays notification titles and bodies in the operating system notification area and navigates the user into the application when the user opens the notification as output.

### Step 31:

User continues iterative interaction.

User receives new questions, proposals, or notifications on the terminal as input.

User continues providing answers, making selections, and ignoring or accepting proposals as output, thereby supplying ongoing data that the server uses to refine profiles and future recommendations.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

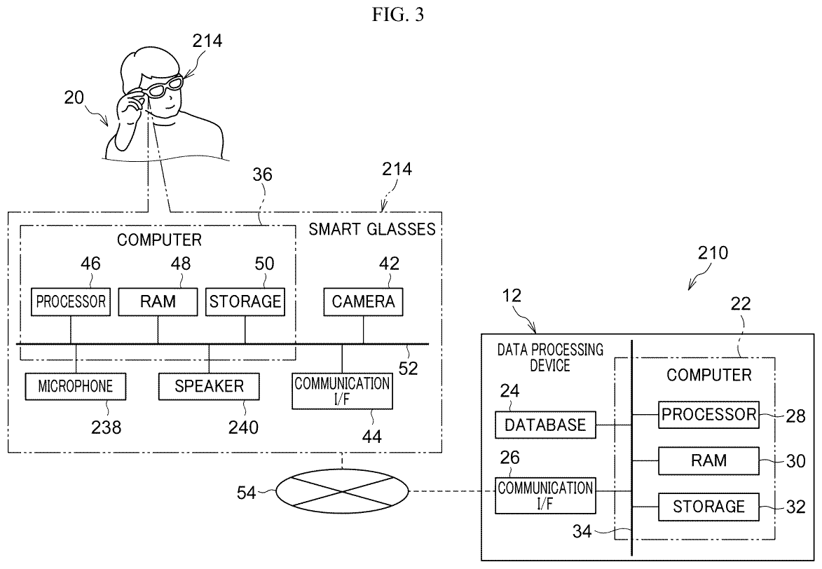

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

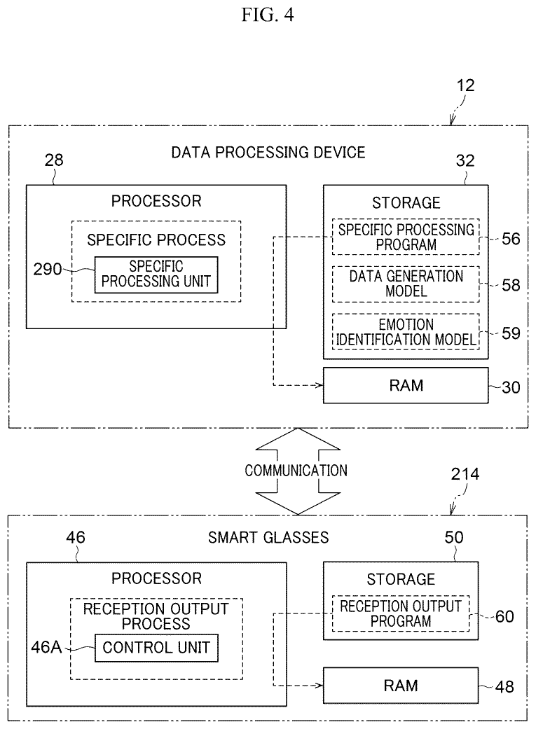

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

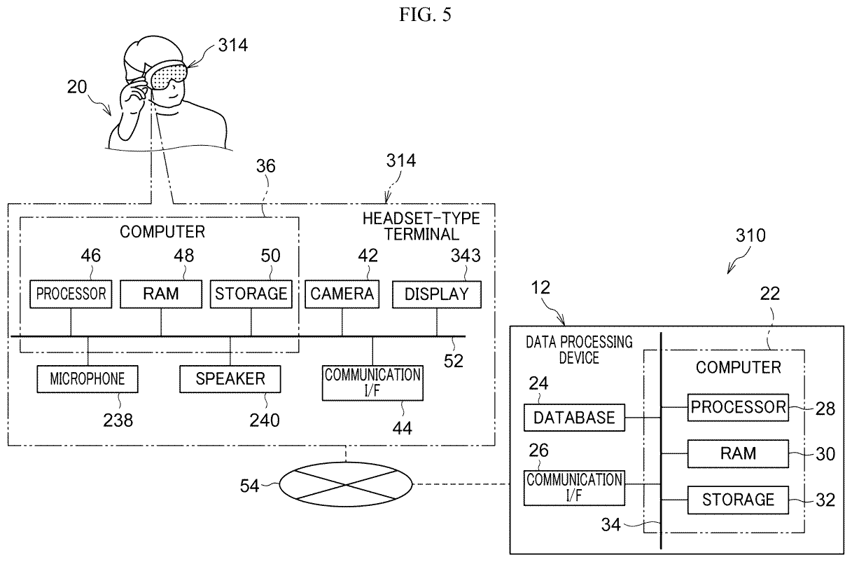

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

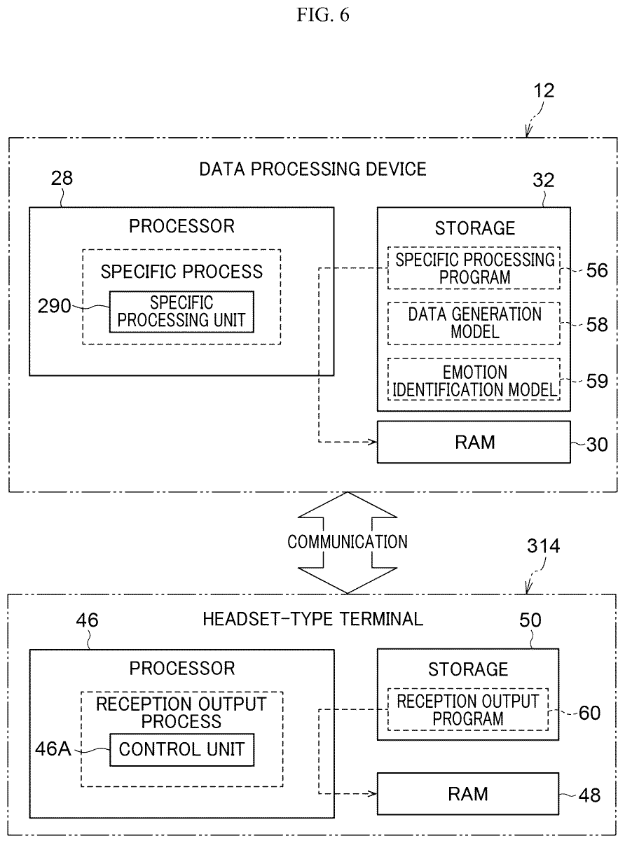

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

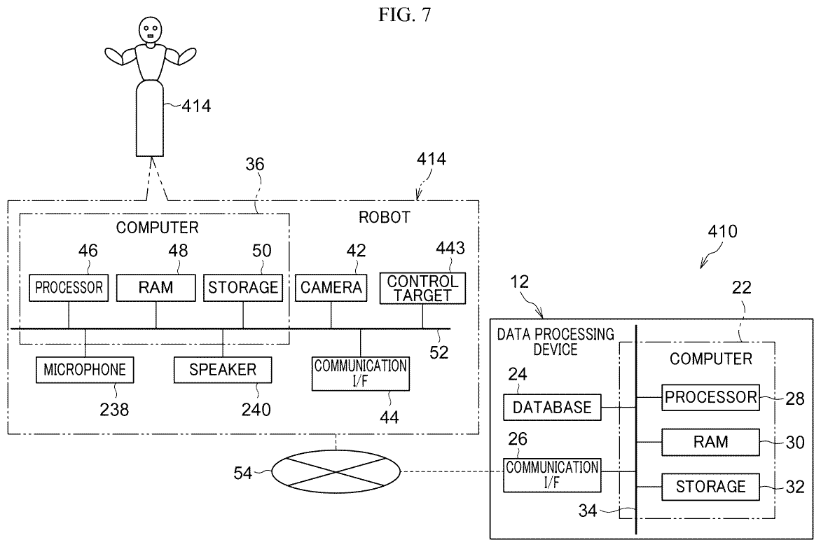

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

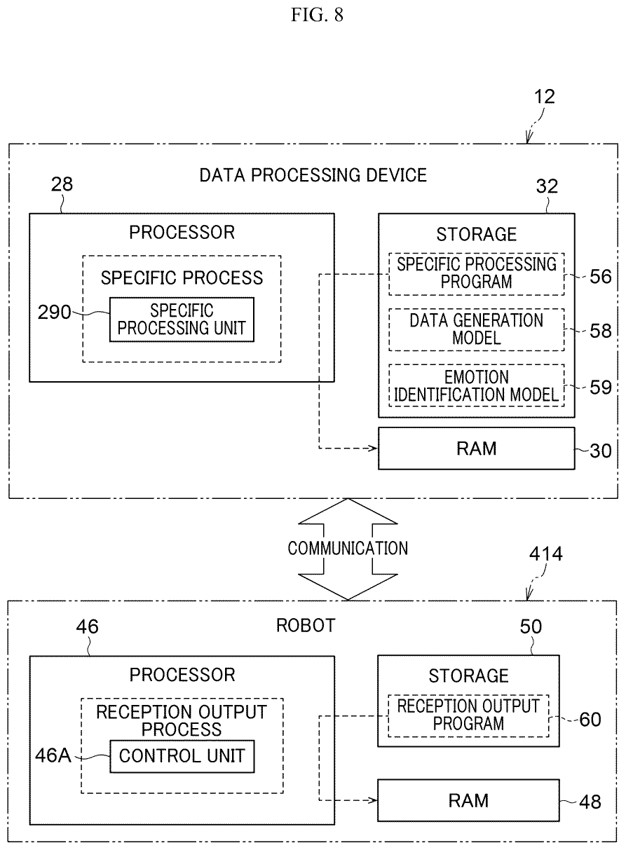

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

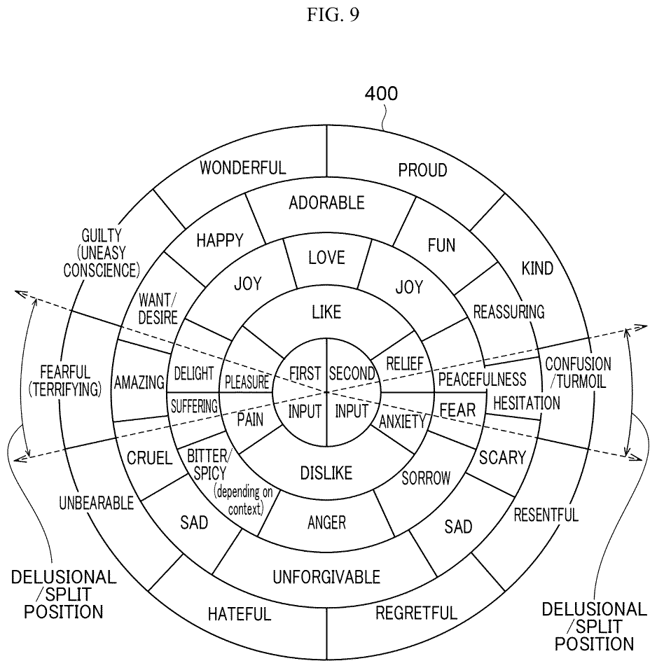

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

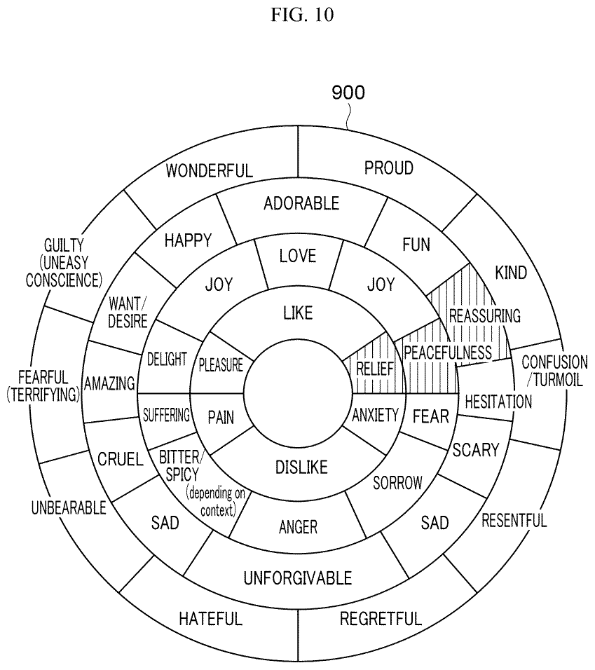

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive target information from a user via an operation device and acquire the target information as structured data,
store the structured data in a storage device, extract the structured data from the storage device, perform preprocessing on the structured data, and generate feature data for each user based on purchase history information and preference information included in the structured data,
apply a machine learning algorithm to the feature data to extract behavioral characteristics and classify user groups according to the behavioral characteristics,
generate a prompt sentence including information on the user groups and the behavioral characteristics, the prompt sentence instructing generation of optimal event measures, execute a generative information processing model using the prompt sentence and the information on the user groups to generate event measure candidates described in natural language for each of the user groups,
convert the event measure candidates into structured data, transmit the structured data to the operation device, and cause a display device of the operation device to display the event measure candidates,
receive, from the operation device, modification content or confirmation instructions from the user with respect to the event measure candidates, and store, in the storage device, the event measure candidates as finalized measures on the basis of the modification content or the confirmation instructions, and
re-input the finalized measures and result information related to the finalized measures into the machine learning algorithm and the generative information processing model so as to update subsequent generation processing of the event measure candidates.

### Supplementary 2

The system according to Supplementary 1,
wherein the processor is configured to
analyze information on an emotional state of the user acquired from the operation device and adjust content of the prompt sentence and the event measure candidates according to the emotional state.

### Supplementary 3

The system according to supplementary 1,
wherein the processor is configured to
notify the user of adjusted event measure candidates via an operation device including a portable information processing apparatus, acquire response information from the user via the operation device, and store the response information as part of the finalized measures and the result information in the storage device.

### Application Example 1

### Supplementary 1

A system comprising a processor and a storage device,
wherein the processor is configured to
receive information including identification information from a user and, based on the identification information, acquire transaction history information and preference information associated with the user from the storage device,
preprocess the acquired transaction history information and preference information by using an information processing program, generate feature data including numerical feature values, and input the feature data into a trained information processing model to obtain an analysis result indicating a degree of interest of the user,
generate a prompt sentence for input to a generative information processing model based on the analysis result and the transaction history information and the preference information, input the prompt sentence into the generative information processing model, and cause the generative information processing model to generate natural language text indicating content of a personalized sales promotion event measure for the user,
extract structured event information including at least an event name, an implementation place, an implementation period, and a target product group from the generated natural language text of the sales promotion event measure, and register the structured event information in association with the identification information in the storage device,
acquire position information from a portable information terminal device, compare the position information with facility position information stored in the storage device to calculate a distance between a current position of the user and a facility, and determine, based on the distance and the implementation period, whether or not the structured event information is a notification target,
generate, according to a result of the determination, a notification message based on the structured event information and transmit the notification message to the portable information terminal device via a communication network, and
receive response information including participation information with respect to the notification message from the portable information terminal device, record the response information in association with the identification information in the storage device, and accumulate the response information as learning data for use as input data for the trained information processing model and the generative information processing model.

### Supplementary 2

The system according to supplementary 1,
wherein the processor is configured to adjust content of the prompt sentence so as to include information indicating a participation tendency of the user for past event measures included in the response information when generating the prompt sentence.

### Supplementary 3

The system according to supplementary 1,
wherein the processor is configured to include, in the notification message transmitted to the portable information terminal device, an event summary, an advantage description, and participation operation information generated based on the natural language text of the sales promotion event measure generated by the generative information processing model.

### Example 2

### Supplementary 1

A system comprising a processor,
wherein the processor is configured to
acquire, from an information storage apparatus, attribute information and transaction history information of a user based on identification information, and generate profile information of the user based on the attribute information and the transaction history information,
create a prompt sentence including a description containing the profile information and question generation conditions, request generation of an inquiry sentence from a generative AI model having a natural language processing function by using the prompt sentence, and obtain the inquiry sentence output from the generative AI model,
cause an information terminal apparatus having a communication function to present the inquiry sentence to the user and obtain a free-form response sentence input by the user via the information terminal apparatus,
execute natural language analysis processing on the response sentence, the natural language analysis processing including at least one of morphological analysis, phrase extraction, semantic interpretation, and classification processing, and extract preference information including interest-target category information and requested feature information from the response sentence,
update user preference information stored in the information storage apparatus based on the preference information, and
acquire candidate measure information from the information storage apparatus in which event information or promotion information is stored, calculate a relevance degree of the candidate measure information based on the updated user preference information, select optimal event measure information to be presented to the user based on the relevance degree, and instruct presentation of the optimal event measure information to the user via the information terminal apparatus.

### Supplementary 2

The system according to supplementary 1,
wherein the processor is configured to estimate emotion state information from the response sentence in the natural language analysis processing, and adjust at least one of content and presentation timing of the optimal event measure information based on both the emotion state information and the preference information.

### Supplementary 3

The system according to supplementary 1,
wherein the processor is configured to personalize dialogue content stepwise by inputting, into the generative AI model, a prompt sentence including at least one of the profile information and past dialogue history information for both generation of the inquiry sentence and analysis of the response sentence, and to sequentially update the user preference information at each stage of the dialogue based on newly acquired preference information.

### Application Example 2

### Supplementary 1

A system comprising a processor,
wherein the processor is configured to
receive input information from a user as user input acquisition processing,
analyze dialog history information and user attribute information including the input information to extract or update purchase history information and preference information as profile update processing,
specify emotional state information on the basis of voice information or character information included in the input information as emotion estimation processing,
generate a prompt sentence on the basis of the purchase history information, the preference information, and the emotional state information, the prompt sentence being used to determine candidate measure information and explanation text information to be presented to the user as prompt generation processing,
operate a generative AI model by using the prompt sentence as input and cause the generative AI model to generate proposal information including recommended product information, recommended event information, or recommended campaign information as proposal generation processing,
adjust content or presentation order of the proposal information in accordance with the emotional state information as proposal adjustment processing,
transmit the proposal information as notification information to an information processing terminal and cause the information processing terminal to present the proposal information to the user as notification processing, and
record response information from the user and the emotional state information as dialog history information and reflect the dialog history information in subsequent generation of the prompt sentence and subsequent generation of the proposal information as learning data update processing.

### Supplementary 2

The system according to supplementary 1,
wherein the processor is configured to extract acoustic feature information from the voice information included in the input information, estimate the emotional state information in multiple stages on the basis of the acoustic feature information and the character information, and add the estimated emotional state information to the prompt sentence to be input to the generative AI model.

### Supplementary 3

The system according to supplementary 1,
wherein the processor is configured to transmit the notification information by using a push distribution function toward the information processing terminal, collect viewing history information and selection history information of the user with respect to proposal content included in the notification information transmitted by the push distribution function, and accumulate the viewing history information and the selection history information as the purchase history information and the preference information by the learning data update processing.

What is claimed is:

1. A system comprising:
circuitry configured to:
receive, via a communication interface coupled to a packet-switched network, target information from a terminal device, and acquire the target information as structured data in a storage device;
extract the structured data from the storage device, perform preprocessing on the structured data to generate feature data for each user based on behavior history records and preference information included in the structured data;
apply a machine learning algorithm to the feature data to extract behavioral characteristics and classify cluster segments according to the behavioral characteristics;
generate a prompt sentence including the cluster segment information and the behavioral characteristics, execute inference processing using a generative neural network model with the prompt sentence as input to generate content recommendation data for each cluster segment, and convert the content recommendation data into structured output data;
transmit the structured output data to the terminal device via the communication interface, receive modification content or confirmation instructions from the terminal device, and store finalized content data based on the modification content or the confirmation instructions in the storage device; and
re-input the finalized content data and result information into the machine learning algorithm and the generative neural network model to update subsequent generation processing.

2. The system according to claim 1, wherein the circuitry is configured to perform the preprocessing by applying at least one of normalization, encoding, and feature extraction to the structured data to generate the feature data.

3. The system according to claim 2, wherein the circuitry is configured to apply the machine learning algorithm by executing at least one of a clustering algorithm and a classification algorithm on the feature data to group records into the cluster segments based on behavioral characteristic similarity.

4. The system according to claim 3, wherein the circuitry is configured to extract behavioral characteristics comprising at least one of frequency metrics, recency metrics, and preference weight vectors from the feature data for inclusion in the prompt sentence.

5. The system according to claim 4, wherein the circuitry is configured to generate the prompt sentence by embedding the cluster segment information, the behavioral characteristics, and an instruction for generating content recommendation data for each cluster segment into a natural language template.

6. The system according to claim 5, wherein the circuitry is configured to include an affective state parameter derived from the terminal device in the prompt sentence to cause the generative neural network model to adjust a tone and timing of the content recommendation data in accordance with the affective state parameter.

7. The system according to claim 6, wherein the circuitry is configured to acquire the affective state parameter by analyzing text input or interaction behavior received from the terminal device using an affective recognition model.

8. The system according to claim 1, wherein the circuitry is configured to convert the content recommendation data from natural language format into structured output data by parsing content fields, benefit fields, and timing fields from the content recommendation data.

9. The system according to claim 8, wherein the circuitry is configured to display the structured output data on a display device of the terminal device as candidate content items for each cluster segment, with each candidate associated with corresponding content fields and timing fields.

10. The system according to claim 1, wherein the circuitry is configured to re-input the finalized content data into the machine learning algorithm by computing updated behavioral characteristic features from the result information, and updating cluster segment membership assignments based on the updated features.

11. The system according to claim 10, wherein the circuitry is configured to re-input the finalized content data into the generative neural network model by including the finalized content data and the result information in a subsequent prompt sentence as historical context data.

12. The system according to claim 1, wherein the circuitry is configured to store the prompt sentence, the content recommendation data, and the finalized content data as record information in the storage device, and compute performance metrics from the result information to evaluate content recommendation effectiveness.

13. The system according to claim 12, wherein the circuitry is configured to update model parameters of the machine learning algorithm based on the computed performance metrics to improve subsequent cluster segment classification.

14. The system according to claim 1, wherein the circuitry is configured to transmit the finalized content data to smart devices associated with respective cluster segments via the communication interface for delivery to users in the cluster segments.

15. The system according to claim 14, wherein the circuitry is configured to schedule transmission of the finalized content data based on a timing parameter extracted from the content recommendation data.

16. The system according to claim 1, wherein the circuitry is configured to retrieve, from the storage device, prior content recommendation data associated with similar cluster segments using a similarity search, and incorporate the retrieved prior data as context in a subsequent prompt sentence.

17. The system according to claim 16, wherein the circuitry is configured to compute a similarity score between a vector representation of a current prompt sentence and vector representations of stored record information entries, and retrieve entries having similarity scores exceeding a threshold value.

18. A system comprising:
circuitry configured to:
receive, via a communication interface coupled to a packet-switched network, target information from a terminal device, and acquire the target information as structured data in a storage device;
extract the structured data, perform preprocessing to generate feature data based on behavior history records and preference information, and apply a machine learning algorithm to extract behavioral characteristics and classify cluster segments;
generate a prompt sentence comprising cluster segment information, behavioral characteristics, and an affective state parameter, and execute inference processing using a generative neural network model with the prompt sentence as input to generate content recommendation data for each cluster segment;
convert the content recommendation data into structured output data, transmit the structured output data to the terminal device via the communication interface, receive confirmation instructions, and store finalized content data in the storage device; and
re-input the finalized content data and result information into the machine learning algorithm and the generative neural network model to update cluster segment classification and subsequent content recommendation generation.

19. The system according to claim 18, wherein the circuitry is configured to compute performance metrics from the result information, update model parameters of the machine learning algorithm based on the performance metrics, and update generation conditions of the generative neural network model based on stored record information.

20. A method comprising:
receiving, via a communication interface coupled to a packet-switched network, target information from a terminal device, and acquiring the target information as structured data in a storage device;
extracting the structured data from the storage device, performing preprocessing on the structured data to generate feature data for each user based on behavior history records and preference information included in the structured data;
applying a machine learning algorithm to the feature data to extract behavioral characteristics and classify cluster segments according to the behavioral characteristics;
generating a prompt sentence including the cluster segment information and the behavioral characteristics, executing inference processing using a generative neural network model with the prompt sentence as input to generate content recommendation data for each cluster segment, and converting the content recommendation data into structured output data;
transmitting the structured output data to the terminal device via the communication interface, receiving modification content or confirmation instructions from the terminal device, and storing finalized content data based on the modification content or the confirmation instructions in the storage device; and
re-inputting the finalized content data and result information into the machine learning algorithm and the generative neural network model to update subsequent generation processing.
